(19) United States
(12) Patent Application Publication
(10) Pub. No.: US 2002/0154694 A1
(43) Pub. Date: Oct. 24, 2002

(54) BIT STREAM SPLICER WITH VARIABLE-RATE OUTPUT

(76) Inventor: CHRISTOPHER H. BIRCH, TORONTO (CA)

Correspondence Address: MILES & STOCKBRIDGE P.P., 1751 PINNACLE DRIVE, SUITE 500, MCLEAN, VA, 22102-3833, US

(21) Appl. No.: 08/927,481

(22) Filed: Sep. 11, 1997

Related U.S. Application Data
(63) Continuation-in-part of application No. 08/823,007, filed on Mar. 21, 1997, now Pat. No. 6,052,384.

(51) Int. Cl. H04N 7/12

(52) U.S. Cl. 375/240.05; 375/240.03

(57) ABSTRACT

A splicer for splicing “live” bit streams such as those which carry video programs that have been encoded according to the MPEG-2 standard. The splicer controls the rate at which it outputs the spliced bit stream by means of a model of the receiver and can thereby prevent overflow or underflow in receivers receiving the spliced bit stream. The splicer also includes analyzers for reading the old bit stream and the new bit stream that is to be spliced to the new bit stream. The analyzers provide information to the receiver model and also permit the splicer to select IN and OUT points in the old and new bit streams that minimize the effect of the splice on the decoding of the bit stream done in the receiver. Where necessary, the splicer modifies the output bit stream to reduce interference with decoding. The splicer does not require splice parameters to select IN and OUT points or to determine the proper bit rate or the spliced bit stream. The splicer is further able to make non-seamless and seamless splices and greatly simplifies the making of undetectable splices. It is also able to splice in response to an external splice signal, to a splice command in a bit stream, or to the presence of the beginning or end of a bit stream in the splicer.

### RELATED PATENT APPLICATION

The present patent application is a continuation-in-part of U.S. Ser. No. 08/823,007, C. Birch, et al., Using a Receiver Model to Multiplex Variable-Rate Bit Streams Having Timing Constraints, filed Mar. 21, 1997. One of the inventors of U.S. Ser. No. 08/823,007 is an inventor of the present patent application and the assignee of that patent application is the assignee of the present patent application. The present patent application contains the entire Detailed Description of U.S. Ser. No. 08/823,007 together with FIGS. 1, 2, 4-12 of the parent patent application. The new material in the child may be found in the section of the Description of Related Art titled Introduction to Splicing, in the sections of the Detailed Description beginning with the section entitled Using the Principles of the Statistical Multiplexer to Implement a Splicer that can Control the Bit Rate of its Output Bit Stream, and in FIGS. 3, 13-16.

### BACKGROUND OF THE INVENTION

1. Field of the Invention

The invention has to do with the transmission of variable-rate bit streams generally and more particularly with splicing such bit streams during transmission.

2. Description of Related Art: FIGS. 1-2

### INTRODUCTION

The following Description of Related Art consists of two parts: an overview of the problem of splicing in digital broadcasting systems that employ encoded digitizations of images or sound and a general overview of the MPEG-2 standard for encoded digital television. The latter overview is taken from the parent of the present patent application.

Introduction to Splicing

In the parent of the present patent application, a model of a receiver of a variable-rate bit stream was used to statistically multiplex a transmission medium among a number of such variable-rate bit streams. The model was used to determine how much bandwidth was required at the present time to prevent the receiver from either receiving the bit stream at a rate faster than it could handle it or at a rate so slow that time constraints for the bit stream could not be satisfied. The bandwidth determination was then used to determine how much of the bandwidth of the transmission medium should be given to the variable-rate bit stream at that point in time.

In the course of further work with the receiver model, one of the inventors of the parent application has come to understand that the receiver model can also make an important contribution to the problem of splicing variable-rate bit streams with time constraints. In broadcasting, a splice occurs when material from one source is followed without interruption by material from another source. One place where splicing occurs is when a local affiliate of a network inserts local material such as local news or a local commercial into a program from the network. At the beginning of the local material, the local affiliate splices the local material to the broadcast at the point where the network material contains a pause for the local material; at the end of the local material, the affiliate splices the resumption of the broadcast to the end of the local commercial.

In analog broadcasting, the receiver immediately outputs the signal it receives and all signals that it receives have the same format. Consequently, the broadcaster can make a splice simply by shifting from one source of material (the network program in the example) to another (the local material) and then back. The broadcaster need only take care that the local material fills the pause.

In digital broadcasting, splicing is much more difficult. In a digital broadcast, audio and video signals are digitized, that is, represented as patterns of bits. The digitizations are then broadcast to a receiver which uses the information in the digitizations to reproduce the original audio and video signals, which it then outputs to a device such as a television receiver. Digitizing a video or audio signal is not difficult, but the results of straightforward digitizations are very large and require too much capacity in the broadcasting network and too much memory in the receiving device. To reduce the size of the digitizations, digital broadcasters encode them, that is, they take advantage of spatial and/or temporal redundancy in the information in the digitizations to reduce their size. The receiver in such a digital broadcasting system must include a decoder that decodes the digitizations before producing the audio or video signals from them.

Encoded digitizations have two properties that are important for the splicing problem:

the size of the digitization of an image varies according to the amount of redundant information in the image;

if the redundant information is temporal, part of the information needed to decode one digitization may be contained in another digitization; These properties in turn have consequences for the receiver. The receiver must of course provide video images to the television set at a constant rate. It must therefore receive the digitizations at a rate such that the receiver's memory will always contain the information it needs to decode a given digitization in time to provided it to the television set at the time required by the constant rate. Moreover, if the broadcaster is using the network and the receiver's memory efficiently, the rate at which the receiver is receiving digitizations will vary over time with the amount of bandwidth available in the broadcasting medium, the size of the digitizations, and the condition of the receiver's memory.

Because the receiver may require more than one encoded digitization to produce a video image and receives digitizations at a rate which varies over time, a broadcaster cannot splice a broadcast consisting of encoded digitizations just by changing from one source to another. Doing nothing more than that will often leave the receiver without the information it needed to decode the digitizations. This can happen in a number of ways:

At the time of the splice the receiver has not received all of the digitizations it needs to finish decoding the digitizations it has already received from the old source.

After the splice, the receiver does not receive all of the digitizations it needs to decoding the digitizations it does receive from the new source.

The rate at which the receiver receives the digitizations changes at the splice and the new rate is too fast or too slow for the receiver's memory.

Techniques for overcoming these problems are essential for the success of commercial digital broadcasting systems. Such systems must be able to easily change the source of a stream of digitizations and must be able to do it in such a way that the user of the receiver is not aware that a splice has taken place. Ideally, the splice would even be undetectable in the stream of digitizations itself. If the splice is detectable, “commercial killer” devices can detect commercials by the splices between them and the program material that contains them and can filter out the commercials.

The MPEG-2 standard includes various parameters in the Systems syntax [ISO/IEC 13818-1 (4)] that may be inserted by the source to assist a splicer. Examples are listed below:

Discontinuity Indicator

Random Access Indicator

Seamless Splice Flag

Splice Countdown

Splice Type

DTS next AU

Various descriptors in PSI tables

It should be noted that the bandwidth overhead may be excessive (particularly for audio) if these parameters are included at every point where a splice is possible, so they should only be used selectively and activated as required by an event scheduling device. Similarly, compression efficiency may be impacted if making an MPEG-2 stream spliceable means restricting the encoding to encoding forms that only refer to previously-encoded digitizations, instead of encoding forms that can refer to both previous and following digitizations.

The MPEG-2 splicing parameters further do nothing to solve the following problems:

Signaling a splice action

Management of scrambled or encrypted elementary streams

PSI, SI table synchronization

Splicing data streams

Data embedded in video user data

Defeating ‘Commercial Killer’ devices It is an object of the invention disclosed herein to provide techniques which simplify the solution of these and other problems of splicing in digital broadcasting systems.

Introduction to the MPEG2 Standard

One of the techniques used for encoding digitizations is the MPEG-2 standard used for digital television. For details on the standard, see Background Information on MPEG-1 and MPEG-2 Television Compression, which could be found in November 1996 at the URL http://www.cdrevolution.com/text/mpeginfo.htm. FIG. 1 shows those details of the MPEG-2 standard that are required for the present discussion. The standard defines a encoding scheme for compressing digital representations of video. The encoding scheme takes advantage of the fact that video images generally have large amounts of spatial and temporal redundancy. There is spatial redundancy because a given video picture has areas where the entire area has the same appearance; the larger the areas and the more of them there are, the greater amount of spatial redundancy in the image. There is temporal redundancy because there is often not much change between a given video image and the ones that precede and follow it in a sequence. The less the amount of change between two video images, the greater the amount of temporal redundancy. The more spatial redundancy there is in an image and the more temporal redundancy there is in the sequence of images to which the image belongs, the fewer the bits that will be needed to represent the image.

Maximum advantage for the transmission of images encoded using the MPEG-2 standard is obtained if the images can be transmitted at variable bit rates. The bit rates can vary because the rate at which a receiving device receives images is constant, while the images have varying number of bits. A large image therefore requires a higher bit rate than a small image, and a sequence of MPEG images transmitted at variable bit rates is a variable-rate bit stream with time constraints. For example, a sequence of images that shows a “talking head” will have much more spatial and temporal redundancy than a sequence of images for a commercial or MTV song presentation, and the bit rate for the images showing the “talking head” will be far lower than the bit rate for the images of the MTV song presentation.

The MPEG-2 compression scheme represents a sequence of video images as a sequence of pictures, each of which must be decoded at a specific time. There are three ways in which pictures may be compressed. One way is intra-coding, in which the compression is done without reference to any other picture. This encoding technique reduces spatial redundancy but not time redundancy, and the pictures resulting from it are generally larger than those in which the encoding reduces both spatial redundancy and temporal redundancy. Pictures encoded in this way are called I-pictures. A certain number of I-pictures are required in a sequence, first, because the initial picture of a sequence is necessarily an I-picture, and second, because I-pictures permit recovery from transmission errors.

Time redundancy is reduced by encoding pictures as a set of changes from earlier or later pictures or both. In MPEG-2, this is done using motion compensated forward and backward predictions. When a picture uses only forward motion compensated prediction, it is called a Predictive-coded picture, or P picture. When a picture uses both forward and backward motion compensated predictions, it is called a Bidirectional predictive-coded picture, or a B picture in short. P pictures generally have fewer bits than I pictures and B pictures have the smallest number of bits. The number of bits required to encode a given sequence of pictures in MPEG-2 is thus dependent on the distribution of picture coding types mentioned above, as well as the picture content itself. As will be apparent from the foregoing discussion, the sequence of pictures required to encode the images of the “talking heads” will have fewer and smaller I pictures and smaller B and P pictures than the sequence required for the MTV song presentation, and consequently, the MPEG-2 representation of the images of the talking heads will be much smaller than the MPEG-2 representation of the images of the MFV sequence.

The MPEG-2 pictures are being received by a low-cost consumer electronics device such as a digital television set or a set-top box provided by a CATV service provider. The low cost of the device strictly limits the amount of memory available to store the MPEG-2 pictures. Moreover, the pictures are being used to produce moving images. The MPEG-2 pictures must consequently arrive in the receiver in the right order and with time intervals between them such that the next MPEG-2 picture is available when needed and there is room in the memory for the picture which is currently being sent. In the art, a memory which has run out of data is said to have underflowed, while a memory which has received more data than it can hold is said to have overflowed In the case of underflow, the motion in the TV picture must stop until the next MPEG-2 picture arrives, and in the case of overflow, the data which did not fit into memory is simply lost.

FIG. 1 is a representation of a digital picture source 103 and a television 117 that are connected by a channel 114 that is carrying a MPEG-2 bit stream representation of a sequence of TV images. In system 101, a digital picture source 103 generates uncompressed digital representations of images 105, which go to variable bit rate encoder 107. Encoder 107 encodes the uncompressed digital representations to produce variable rate bit stream 109. Variable rate bit stream 109 is a sequence of compressed digital pictures 111 of variable length. As indicated above, when the encoding is done according to the MPEG-2 standard, the length of a picture depends on the complexity of the image it represents and whether it is an I picture, a P picture, or a B picture. Additionally, the length of the picture depends on the encoding rate of VBR encoder 107. That rate can be varied. In general, the more bits used to encode a picture, the better the picture quality.

Bit stream 109 is transferred via a channel 114 to VBR decoder 115, which decodes the compressed digital pictures 111 to produce uncompressed digital pictures 105. These in turn are provided to television 117. If television 117 is a digital television, they will be provided directly; otherwise, there will be another element which converts uncompressed digital pictures 105 into standard analog television signals and then provides those signals to television 117. There may of course be any number of decoders 115 receiving the output of a single encoder 107.

In FIG. 1, channel 114 transfers bit stream 109 as a sequence of packets 113. The compressed digital pictures 111 thus appear in FIG. 1 as varying-length sequences of packets 113. Thus, picture 111(d) has n packets while picture 111(a) has k packets. Included in each picture 111 is timing information 112. Timing information 112 contains two kinds of information: clock information and time stamps. Clock information is used to synchronize decoder 115 with encoder 107. The time stamps specify when a picture is to be decoded and when it is actually to be displayed. The times specified in the time stamps are specified in terms of the clock information. As indicated above, VBR decoder 115 contains a relatively small amount of memory for storing pictures 113 until they are decoded and provided to TV 117. This memory is shown at 119 in FIG. 1 and is termed in the following the decoder's bit buffer. Bit buffer 119 must be at least large enough to hold the largest possible MPEG-2 picture. Further, channel 114 must provide the pictures 111 to bit buffer 119 in such fashion that decoder 115 can make them available at the proper times to TV 117 and that bit buffer 119 never overflows or underflows. Bit buffer 119 underflows if not all of the bits in a picture 111 have arrived in bit buffer 119 by the time specified in the picture's time stamp for decoder 115 to begin decoding the picture 111.

Providing pictures 111 to VBR decoder 115 in the proper order and at the proper times is made more complicated by the fact that a number of channels 114 may share a single very high bandwidth data link. For example, a CATV provider may use a satellite link to provide a large number of TV programs from a central location to a number of CATV network head ends, from which they are transmitted via coaxial or fiber optic cable to individual subscribers or may even use the satellite link to provide the TV programs directly to the subscribers. When a number of channels share a medium such as a satellite link the medium is said to be multiplexed among the channels.

FIG. 2 shows such a multiplexed medium. A number of channels 114(0) through 114(n) which are carrying packets containing bits from variable rate bit streams 109(0 . . . n) are received in multiplexer 203, which processes the packets as required to multiplex them onto high bandwidth medium 207. The packets then go via medium 207 to demultiplexer 209, which separates the packets into the packet streams for the individual channels 114(0 . . . n). A simple way of sharing a high bandwidth medium among a number of channels that are carrying digital data is to repeatedly give each individual channel 114 access to the high bandwidth medium for a short period of time, termed herein a slot.

One way of doing this is shown at 210 in FIG. 2. The short period of time appears at 210 as a slot 213; during a slot 213, a fixed number of packets 113 belonging to a channel 114 may be output to medium 207. Each channel 114 in turn has a slot 213, and all of the slots taken together make up a time slice 211. When medium 207 is carrying channels like channel 114 that have varying bit rates and time constraints, slot 213 for each of the channels 114 must output enough packets to provide bits at the rate necessary to send the largest pictures 111 to channel 114 within channel 114's time, overflow, and underflow constraints. Of course, most of the time, a channel's slot 213 will be outputting fewer packets than the maximum to medium 207, and sometimes may not be carrying any packets at all. Since each slot 213 represents a fixed portion of medium 207's total bandwidth, any time a slot 213 is not full, a part of medium 207's bandwidth is being wasted.

In order to avoid wasting the bandwidth of medium 207, a technique is used which ensures that time slice 211 is generally almost full of packets. This technique is termed statistical multiplexing. It takes advantage of the fact that at a given moment of time, each of the channels in a set of channels will be carrying bits at a different bit rate, and the bandwidth of medium 207 need only be large enough at that moment of time to transmit what the channels are presently carrying, not large enough to transmit what all of the channels could carry if they were transmitting at the maximum rate. The output of the channels is analyzed statistically to determine what the actual maximum rate of output for the entire set of channels will be and the bandwidth of medium 207 is sized to satisfy that actual peak rate. Typically, the bandwidth that is determined in this fashion will be far less than is required for multiplexing in the manner shown at 210 in FIG. 2. As a result, more channels can be sent in a given amount of bandwidth. At the level of slots, what statistical multiplexing requires is a mechanism which in effect permits a channel 114 to have a slot in time slice 211 which varies in length to suit the actual needs of channel 114 during that time slice 211. Such a time slice 211 with varying-length slots 215 is shown at 214.

### SUMMARY OF THE INVENTION

Splicing variable-rate bit streams is simplified and the problems described above are either eliminated or become easier to deal with if the splicer can vary the bit rate of its output stream in such a fashion that the new bit stream will not cause overflow or underflow in the receiver. The splicer disclosed herein includes a bit rate determiner which determines the output rate necessary to prevent overflow or underflow as a result of the splice and an output controller which responds to the bit rate determiner by outputting the output stream at the rate determined by the bit rate determiner. In one aspect of the invention, the bit rate determiner continuously determines the bit rate of the output stream so that the buffer neither overflows nor underflows. In another aspect of the invention, the bit rate determiner uses a model of the receiver to determine the output rate.

In yet another aspect of the invention, the bit streams include encoded components and the splicer includes bit-stream analyzers for analyzing the old and new bit streams to find the components. The output controller uses information from the bit-stream analyzers to locate an out point in the old bit stream where output of the old bit stream may cease and an in point in the new bit stream where output of the new bit stream may begin. The output controller selects the in and out points to minimize interference by the splice with decoding in the receiver. The capability of locating in and out points “on the fly” makes it possible for the splicer to splice a “live” bit stream to another “live” bit stream. The splicer is further capable of splicing a pre-recorded bit stream to a “live” bit stream. The combination of the bit-stream analyzers with the bit rate determiner and the output controller makes it possible to do splicing without the need for explicit splicing information in either of the bit streams being spliced.

The splicer further includes an output bit-stream modifier which modifies the output stream if necessary so that the splice does not interfere at all with decoding in the receiver. The splicer is capable of producing splices which are non-seamless or seamless, and greatly facilitates the production of undetectable splices. It can do the splicing in response to an external splice signal, in response to a splice command in any of the bit streams, or in response to the beginning of the new bit stream or the end of the old bit stream in the splicer.

These and other aspects and objects of the invention will become apparent to those skilled in the arts to which the invention pertains upon perusal of the following Detailed Description and Drawing, wherein:

### BRIEF DESCRIPTION OF THE DRAWING

FIG. 1 is a diagram showing how digital television pictures are encoded, transmitted, and decoded;

FIG. 2 is a diagram showing multiplexing of variable-rate bit streams onto a high band width medium;

FIG. 3 is a high-level block diagram of a splicer;

FIG. 4 is a block diagram of a statistical multiplexer which is used with a preferred embodiment of the invention;

FIG. 5 is a more detailed block diagram of a part of the statistical multiplexer of FIG. 4;

FIG. 6 is pseudo-code for the algorithm used to determine the bit rate of a channel in the statistical multiplexer;

FIG. 7 is a flow chart for the algorithm used to allocate the total bit rate of medium 207 among the channels;

FIG. 8 is a conceptual block diagram of the statistical multiplexer;

FIG. 9 is a high-level block diagram of an encoding system which includes an implementation of the statistical multiplexer;

FIG. 10 is a more detailed view of the implementation of the statistical multiplexer;

FIG. 11 is a detailed view of a channel input block in the statistical multiplexer of FIG. 10;

FIG. 12 is a flowchart of the minimal bitrate algorithm;

FIG. 13 is a detailed block diagram of a preferred embodiment of the splicer;

FIG. 14 is a detailed diagram of a stream for a program in MPEG-2;

FIG. 15 is a detailed diagram of pictures and audio frames in MPEG-2; and

FIG. 16 is a detailed diagram of a splice.

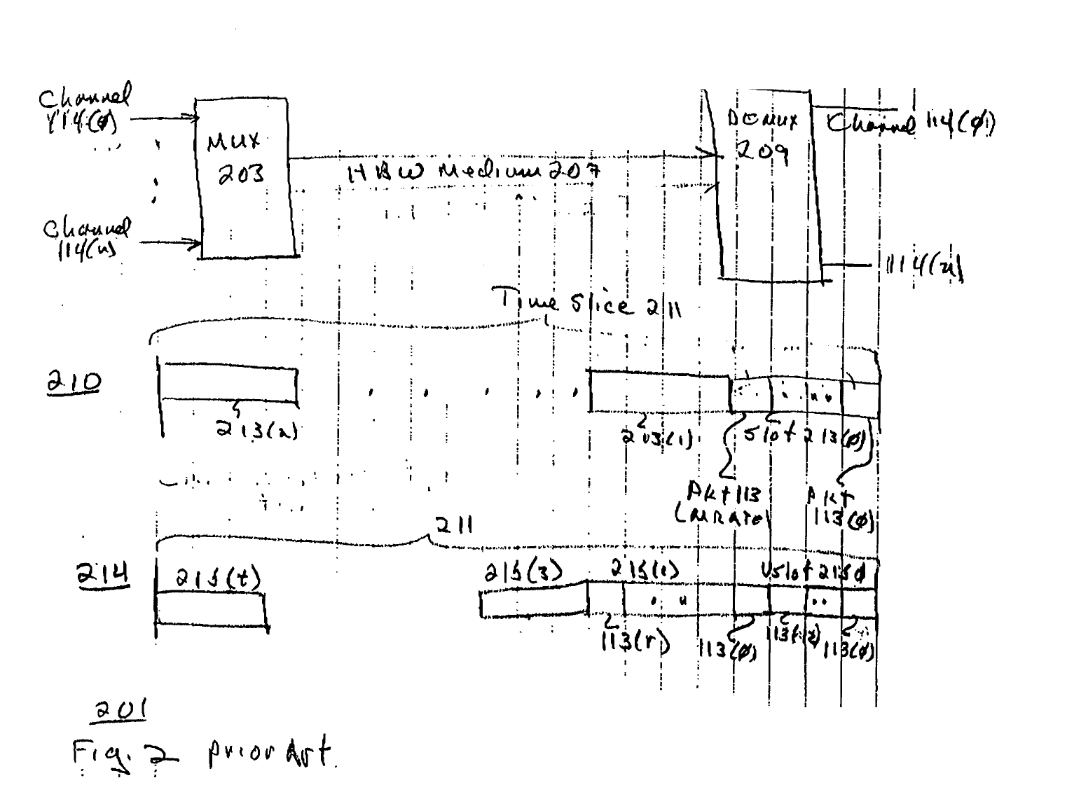

The reference numbers in the drawings have at least three digits. The two rightmost digits are reference numbers within a figure; the digits to the left of those digits are the number of the figure in which the item identified by the reference number first appears. For example, an item with reference number 203 first appears in FIG. 2.

### DETAILED DESCRIPTION

The following Detailed Description will first present an overview of the preferred embodiment, will then provide a description of the hardware in which the preferred embodiment is implemented, and will finally provide a detailed description of the algorithms used to allocate bandwidth in the preferred embodiment.

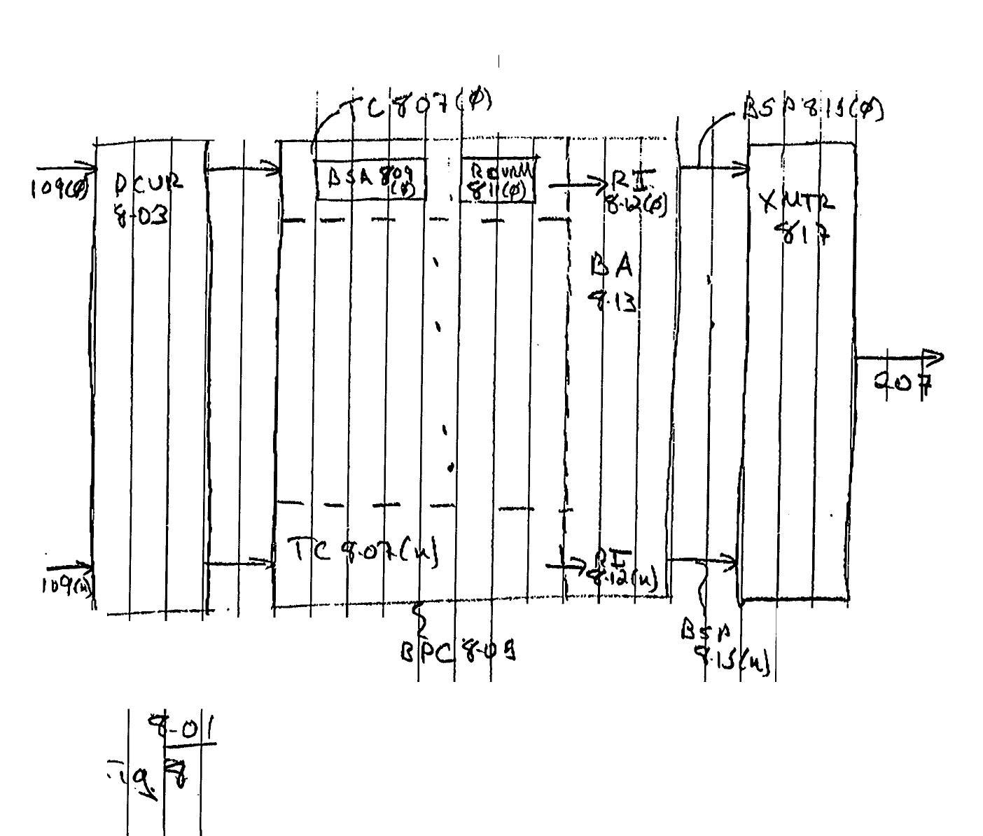

Conceptual Overview: FIG. 8

FIG. 8 presents a conceptual overview of a statistical multiplexer 801 which incorporates the principles of the invention. A number n of variable-rate bit streams 109 are received in receiver 803, which provides them to bandwidth portion controller 805. Bandwidth portion controller 805 dynamically determines what portion of the bandwidth of medium 801 that each bit stream 109(i) is to receive and provides a corresponding portion 815(i) of the bit stream to transmitter 817, which outputs the portions 815(0 . . . n) it receives of each bit stream 109(0 . . . n) onto medium 207.

Bandwidth portion controller 805 has a number of subcomponents. There is a transmission controller 807(i) for each bit stream 109(i). Each transmission controller 807(i) contains a bit stream analyzer 809(i) and a receiver model 811(i). Bit stream analyzer 809(i) collects information from bit stream 109(i) and applies receiver model 811(i) to the collected information to determine what rate is required by the condition of the receiving device. In the case of a MPEG-2 bit stream, the receiving device is a decoder 115(i), and for such a decoder, the required rate can be determined from the time stamps and the sizes of the pictures making up bit stream 109(i). Transmission controller 807(i) applies receiver model 811(i) to this information to determine rate information 812(i). Bandwidth allocator 813 receives rate information 812(0 . . . n) and uses this information to allocate the portion of the bandwidth of medium 207 that each bit stream 109(i) is to receive. Having done this for each bit stream 109(0 . . . n), it provides a bit

stream portion 815(i) that corresponds to the allocated bandwidth to transmitter 817. It is worth noting here that all of the information required by the above technique for allocating bandwidth can be obtained by applying the receiver models 811 to the information received from the bit streams 109 and that information need only be exchanged between bandwidth allocator 813 and transmission controllers 807. There is no need whatever to receive information from or provide information to the encoders 107. Put another way, all of the information needed to allocate the bandwidth is available within statistical multiplexer 801 itself.

It is also worth noting that the technique of using a model of a receiver to control the rate at which a bit stream is output to a receiver may be applied in other situations. For example, a receiver model could be used to control the rate at which a MPEG-2 encoder encoded data.

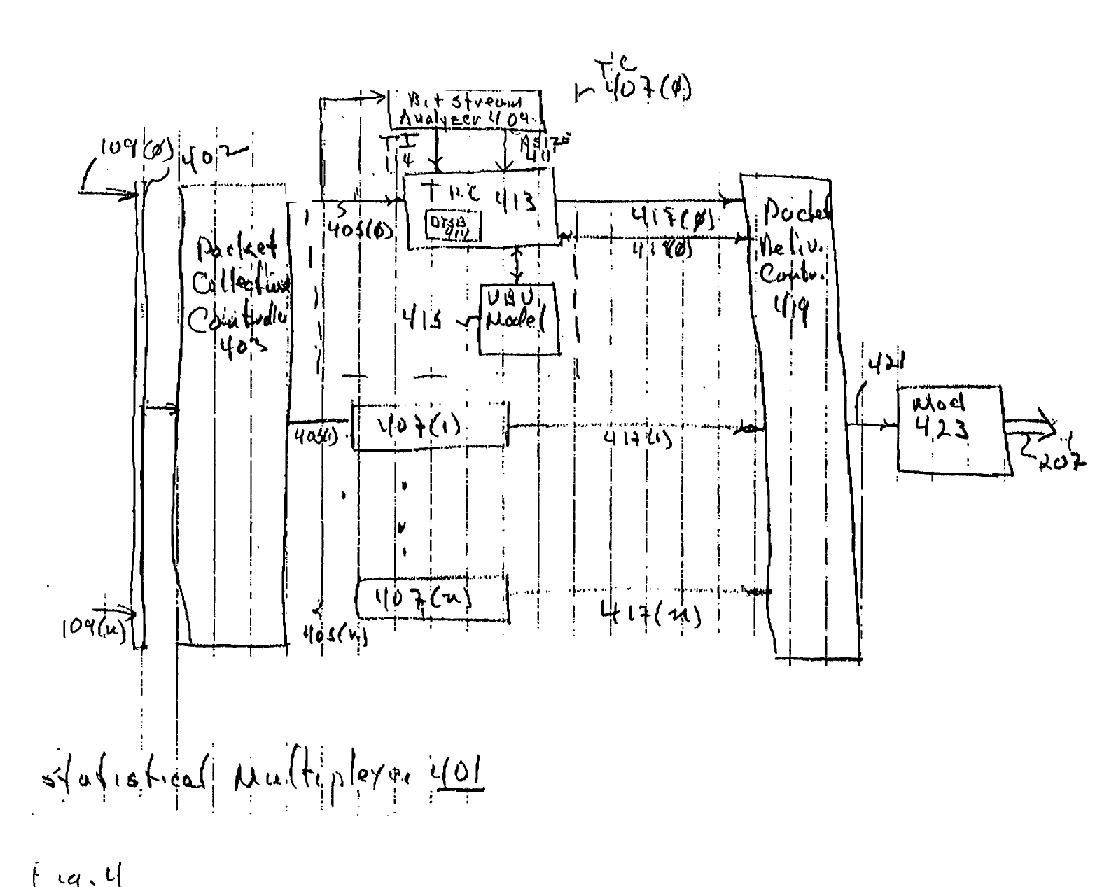

Overview of a Preferred Embodiment: FIG. 4

FIG. 4 provides an overview of a statistical multiplexer 401 for MPEG-2 bit streams which is implemented according to the principles of the invention. The main components of multiplexer 401 are packet collection controller 403, a transmission controller 407(i) for each variable-rate bit stream 109(i), a packet delivery controller 419, and a modulator 423, which receives the output of packet delivery controller 419 and outputs it in the proper form for transmission medium 207. Packet collection controller 403 collects packets from variable-rate bit streams 109(0 . . . n) and distributes the packets that carry a given bit stream 109(i) to the Bit stream's corresponding transmission controller 407(i). In the preferred embodiment, the packets for all of the bit streams 109(0 . . . n) are output to bus 402. Each packet contains an indication of which bit stream it belongs to, and packet collection controller responds to the indication contained in a packet by routing it to the proper transmission controller 407(i). It should be noted here that the packets in each bit stream 109(i) arrive in transmission controller 407(i) in the order in which they were sent by encoder 107(i).

Transmission controller 407(i) determines the rate at which packets from its corresponding bit stream 109(i) is output to medium 207. The actual rate determination is made by transmission rate controller 413, which at a minimum, bases its determination on the following information:

for at least a current picture 111 in bit stream 109(i), the timing information 112 and the size of the current picture.

a Video Buffer Verifier (VBV) model 415(i), which is a model of a hypothetical bit buffer 119(i).

VBV model 415(i) uses the timing information and picture size information to determine a range of rates at which bit stream 109(i) must be provided to the decoder's bit buffer 119(i) if bit buffer 119(i) is to neither overflow nor underflow. Transmission rate controller 413(i) provides the rate information to packet delivery controller 419, which uses the information from all of the transmission controllers 407 to determine during each time slice how the bandwidth of transmission medium 207 should be allocated among the bit streams 109 during the next time slice. The more packets a bit stream 109(i) needs to output during a time slice, the more bandwidth it receives for that time slice.

Continuing in more detail, transmission controller 407 obtains the timing and picture size information by means of bit stream analyzer 409, which reads bit stream 109(i) as it enters transmission controller 407 and recovers the timing information 114 and the picture size 411 from bit stream 109(i). Bit stream analyzer 409 can do so because the MPEG-2 standard requires that the beginning of each picture 111 be marked and that the timing information 114 occupy predetermined locations in each picture 111. As previously explained, timing information 114 for each picture 111 includes a clock value and a decoding time stamp. Transmission controller 407(I) and later decoder 115(I) use the clock value to synchronize themselves with encoder 107(i). The timing information in found in the header of the PES packet that encapsulates the compressed video data. The information is contained in the PTS and DTS time stamp parameters of the PES header. The MPEG-2 standard requires that a time stamp be sent at least every 700 msec. If a compressed picture is not explicitly sent with a compressed picture, then the decoding time can be determined from parameters in the Sequence and Picture headers. For details, see Annex C of ISO/IEC 13818-1. Bit stream analyzer 409 determines the size of a picture simply by counting the bits (or packets) from the beginning of one picture to the beginning of the next picture.

The timing information and the picture size are used in VBV model 415(I). VBV model 415(I) requires the timing information and picture size information for each picture in bit stream 109(I) from the time the picture enters multiplexer 401 until the time the picture is decoded in decoder 115(I). DTS buffer 414 must be large enough to hold the timing information for all of the pictures required for the model. It should be noted here that VBV model 415(i)'s behavior is defined solely by the semantics of the MPEG-2 standard, not by any concrete bit buffer 119(i). Any bit buffer for a working MPEG-2 decoder must be able to provide the decoder with the complete next picture at the time indicated by the picture's timing information; that means that the bit buffer 119(i) for any working MPEG-2 decoder must be at a minimum large enough for the largest possible MPEG-2 picture. Given this minimum buffer size, the timing information for the pictures, and the sizes of the individual pictures, VBV model 415(i) can determine a rate of output for bit stream 109(i) which will guarantee for bit buffers 119(i) of any working MPEG-2 decoder that each picture arrives in the bit buffer 119(i) before the time it is to be decoded and that there will be no overflow of bit buffer 119(i).

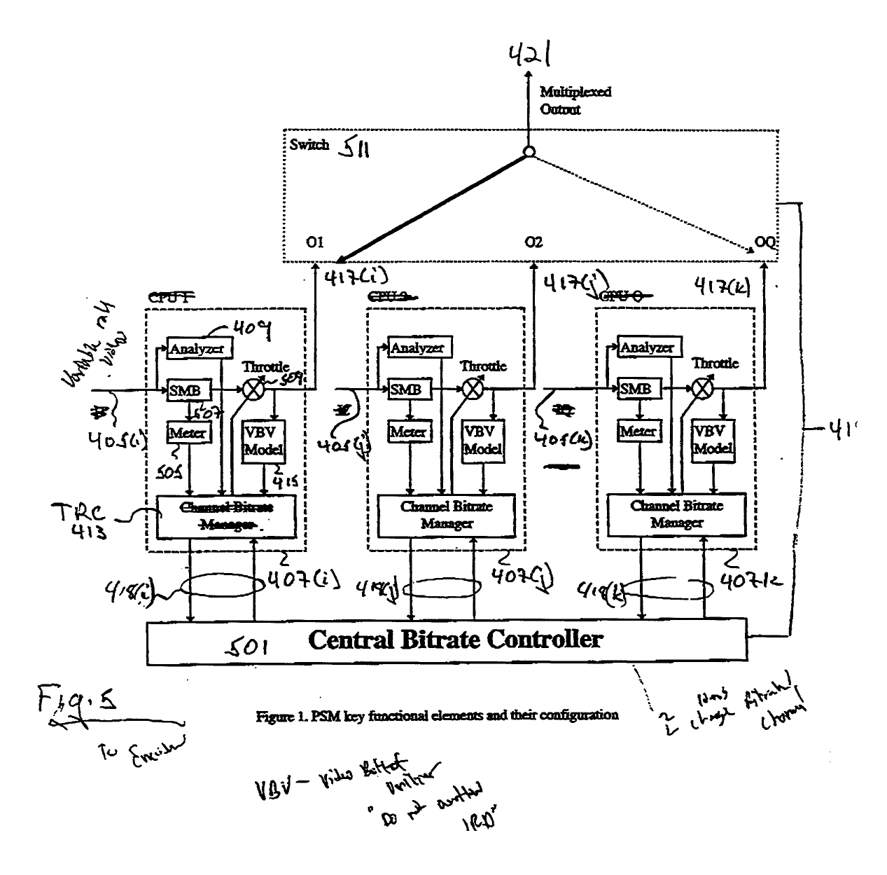

Details of Transmission Controller 407 and Packet Delivery Controller 419: FIG. 5

FIG. 5 shows the details of a preferred embodiment of transmission controller 407 and packet delivery controller 419. The figure shows three of the n transmission controllers, namely transmission controllers 407(i . . . k), and the two major components of packet delivery controller 419, namely central bit rate controller 501 and switch 511. Beginning with transmission controller 407(i), in addition to transmission rate controller 413, analyzer 409, and VBV model 415, transmission controller 409 includes statistical multiplexer buffer (SMB) 507, a meter 505 for buffer 507, and throttle 509. SMB 507(i) is a first-in-first-out pipe buffer which holds the bits of bit stream 109(i) while they are in transmission control 407(i). In the preferred embodiment, SMB 507(i) receives pictures 111 in bursts that contain all or almost all of the bits in the picture, depends on the picture size and maximal bit rate specified by the encoder. Such bursts are termed herein picture pulses, and the time period represented by such a picture pulse is denoted as Tₚ, which is the inverse of video frame rate. For example, Tₚ=1/29.97=33 ms for NTSC video coding. As previously stated, packet delivery controller 419 provides packets in time slices 211. The length of time of one of these slices is denoted herein as T_{c}. In a preferred embodiment, T_{c} is 10 ms.

SMB 507(i) must of course be large enough to be able to accept picture pulses of any size during the time it takes to read out the largest expected picture pulse. SMB 507(i) further must be emptied at a rate that ensures that it cannot overflow, since that would result in the loss of bits from bit stream 109(i). It also should not underflow, since that would result in the insertion of null packets in the bit stream, resulting in the waste of a portion of the multiplexed medium. Meter 505 monitors the fullness of SMB 507(i) and provides information concerning the degree of fullness to TRC 413(i). TRC 413(i) then uses this information to vary the range of bit rates that it provides to packet delivery controller 419 as required to keep SMB 507(i) from overflowing or underflowing. In other embodiments, the degree of fullness from meter 505 can also be fed back to encoder 107(i) and used there to increase or decrease the encoding rate. It should be noted here that feeding back the degree of fullness to encoder 107(i) does not create any dependencies between statistical multiplexer 401 and a given type of encoder 107. Throttle 509, finally, is set by TRC 413 on the basis of information 418(i) that it has received from packet delivery controller 419 to indicate the number of packets 113 that bit stream 109(i) is to provide to medium 207 in time slice 211.

In determining the range, TRC 413 sets the minimum rate for a given time slice 211 to the maximum of the rate required to keep SMB 507 from overflowing and the rate required to keep VBV model 415(I) from underflowing and the maximum rate for the time slice to the minimum of the rate required to keep SMB 507 from underflowing and the rate required to keep VBV model 415(I) from overflowing.

Continuing with packet delivery controller 419, packet delivery controller 419 allocates the packets 113 that can be output during the time slice 211 T_{c} to bit streams 109(0. . . n) as required to simultaneously satisfy the ranges of rates and priorities provided by TRC 413 for each transmission controller 407(i) and maximize the number of packets 113 output during time slice 211. In the preferred embodiment, controller 419 has two components, central bit rate controller 501, which is a processor that analyzes the information received from each of the transmission rate controllers 413 in order to determine how many packets from each bit stream 109(i) are to be output in the next time slice 211, and switch 511, which takes the number of packets 113 permitted by throttle 509(i) for each bit stream 109(i) during the time slice 211. Switch 511 is implemented so as to deliver packets from each throttle 509(i) such that the packets are evenly distributed across time slice 211. Implementing switch 511 in this way reduces the burstiness of the stream of packets 109(i) to decoder 115(i) and thereby reduces the amount of transport packet buffer needed in decoder 115. Such implementations of switch 511 are well-known in the art.

An important advantage of multiplexer 401, or indeed of any statistical multiplexer built according to the principles of the invention is that the multiplexer can simultaneously multiplex both constant-rate and variable-rate bit streams onto medium 207. The reason for this is that as far as statistical multiplexer 401 is concerned, a constant-rate bit stream is simply a degenerate case: it is a varying-rate bit stream whose rate never varies. Thus, with a constant-rate bit stream, JRC 413(i) always returns the same rate information 417(i) to packet delivery controller 419.

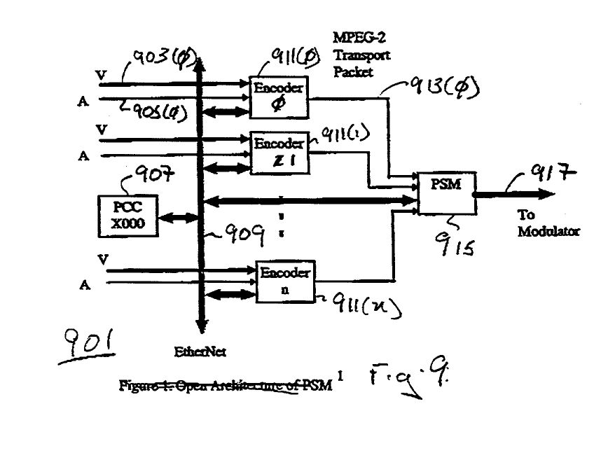

Hardware Implementation of a Preferred Embodiment: FIGS. 9-11

A presently-preferred embodiment of the invention is implemented as a modification of the PowerVu satellite up-link system manufactured by Scientific-Atlanta, Inc. (PowerVu is a trademark of Scientific-Atlanta). FIG. 9 is a high-level block diagram of the PowerVu up-link system as modified to implement the invention. System 901 includes a set of encoders 911(0 . . . n). Each encoder 911(i) encodes a video input 903(i) and an audio input 905(i); the video input is encoded at a constant or variable bit rate and the audio input is encoded at a constant bit rate. Each encoder 911(i) has an output 913(i) which carries the encoded video and audio. In the PowerVu system as modified, the outputs 913(0 . . . n) go to statistical multiplexer 915, which outputs a constant bit-rate stream 917 to a modulator for transmission to a communications satellite. At a high level, operation of all of the components of system 901 is supervised and controlled by control processor 907, which communicates with the other components by means of Ethernet protocol 909 (Ethernet is a registered trademark of Xerox Corporation). In the presently-preferred embodiment, statistical multiplexer 915 is implemented as a separate chassis which need only be coupled to the rest of the PowerVu system by encoded data inputs 913(0 . . . n), Ethernet protocol 909, and output 917.

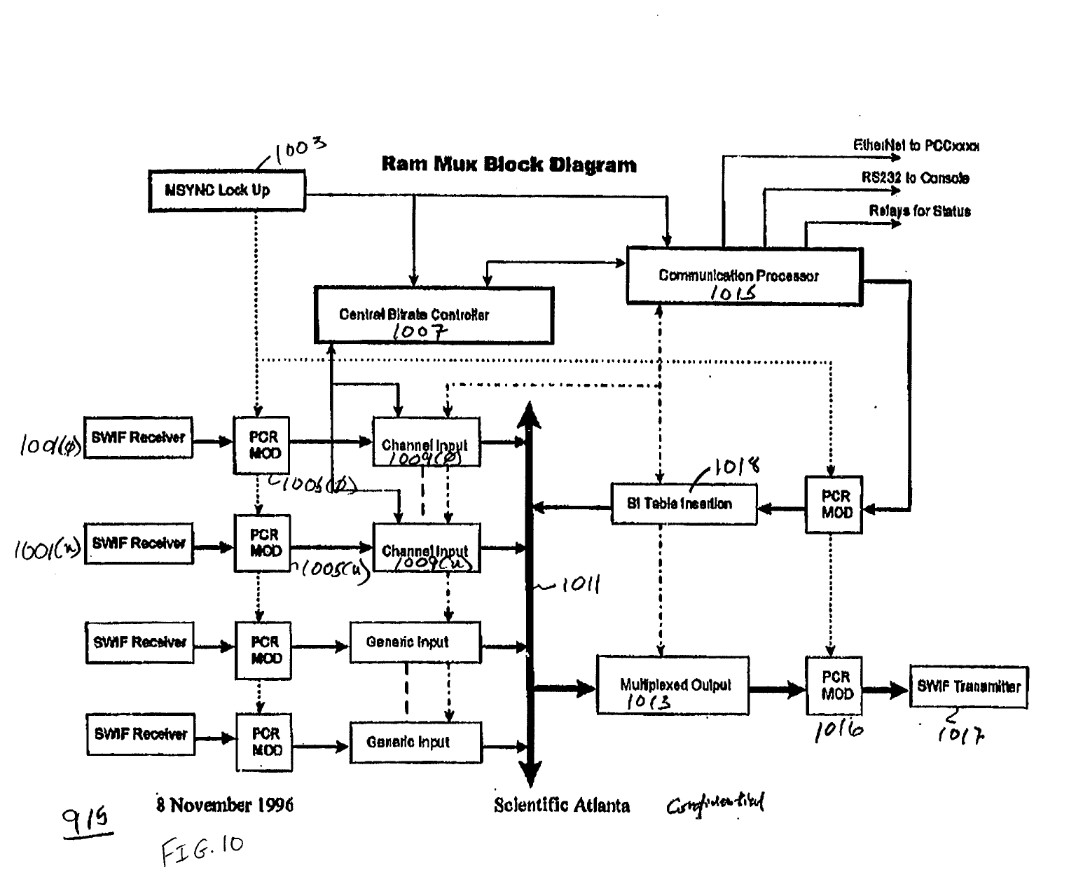

FIG. 10 shows the preferred embodiment of statistical multiplexer 915 in more detail. Multiplexer 915 receives its inputs of encoded video and audio from optical fibers. Each SWIF receiver 1001(i) receives input from a single optical fiber and there are receivers 1001(0 . . . n) corresponding to encoders 911(0 . . . n). Each receiver converts the information from photons to digital electronic form and outputs it via PCR MOD 1005(i) to channel input block 1009(i). PCR MOD 1005(i) corrects the clock information in the encoded video and audio to compensate for any delays in the encoding process. The synchronization information needed to do this is provided by MSYNC lock up 1003.

Channel Input 1009(i) is an implementation of transmission controller 407(i). Channel input 1009(i) employs a software implementation of VBV model 415 to dynamically determine a current rate at which the input from receiver 1001(i) must be output to multiplexed output stream 917 and provides that rate information to central bit rate controller 1007, which in turn actually allocates a specific rate to channel input block 1009(i). Channel input block 1009(i) then outputs bits in its bit stream to bus 1011 at that rate. The combined outputs of blocks 1009(0 . . . n) then go via multiplexed output 1013, PCR MOD 1016, and SWIF transmitter 1017 to output 917. PCR MOD 1016 modifies the clock information in the encoded video again to deal with the time spent in channel input block 1009(i) and outputs the bit stream to SWIF transmitter 1017, which converts the bit stream to a photonic representation and outputs it to an optical fiber. Communication processor 1015 provides high level control to central bitrate controller 1007 and also serves as the interface to PCC 907, a control console, and a system which broadcasts status information. Communications processor 1015 also receives MPEG-2 service information tables from PCC 907 and provides them to service information table insertion 1018, which inserts them into the bit streams.

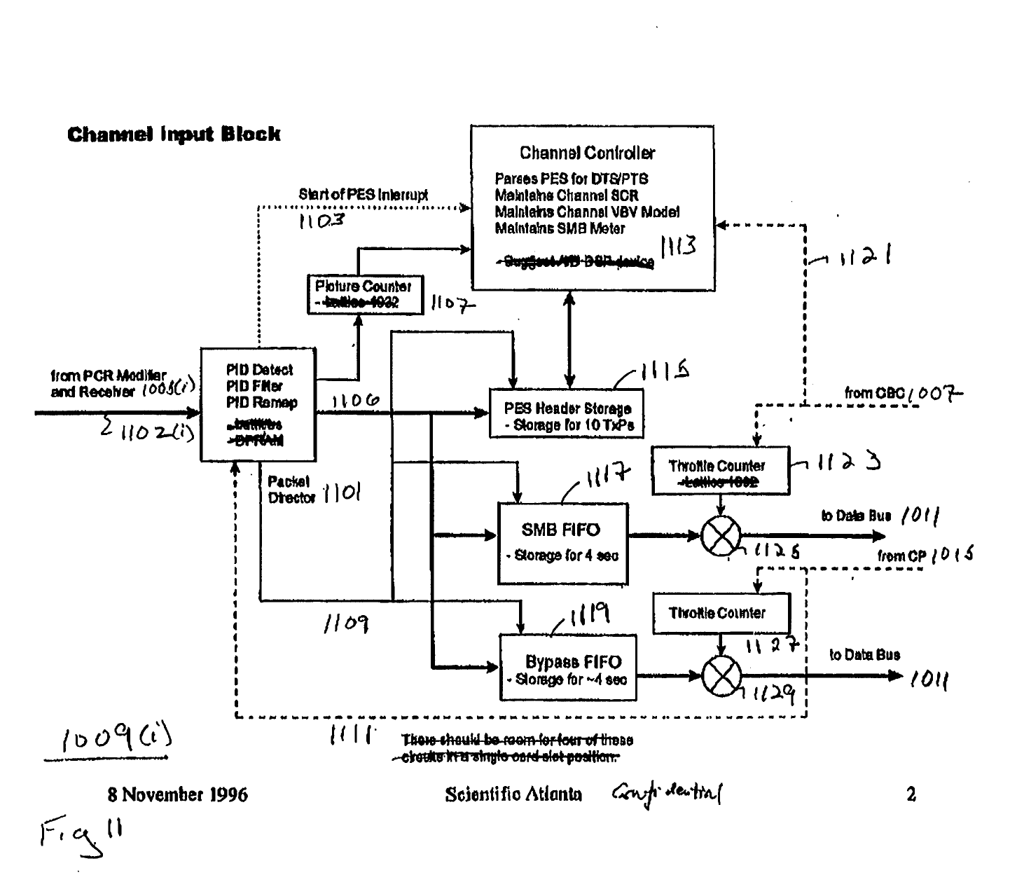

A presently-preferred embodiment of a single channel input block 1009(i) is shown in more detail in FIG. 11. The main components are packet director 1101, which detects audio packets, video packets, and headers and routes them to different components of input block 1009(i), storage 1115 for the headers, storage 1117 for a FIFO (queue) to hold video packets from the time they are received in input block 1009(i) until they are output to data bus 1011, and a bypass FIFO 1119 which holds the constant bit rate audio packets while they are in input block 1009(i). Output from FIFO 1117 is controlled by throttle 1032 under control of throttle counter 1123, which specifies the number of packets to be output from FIFO 1117 during a given time slot. Output from FIFO 1127 is controlled by throttle 1129, which is controlled by throttle counter 1123. Throttle counter 1123 is set by channel controller 1113 in response to the rate selected by central bit rate controller 1007. Throttle counter 1127, which is for a constant-rate bit stream and does not depend on VBV model 415(i), is set directly by central bit rate controller 1007.

Operation of input block 1009(i) is as would be expected. Serial bit stream 1001(i) from SWIF receiver 1001(i) is modified by PCR 1005(i) and is output to packet director 1101, which detects packets, determines their types, and outputs them to the various components of channel input block 1009(i). Packet director 1101 further provides a start of picture interrupt 1103 to channel controller 1113 to indicate that a new picture is being received in SMB FIFO 1117. Channel controller 1113 responds to interrupt 1103 by using picture size information obtained from picture counter 1107, header information stored in header storage 1115, and information about the amount of space left in SMB FIFO 1117 in the VBV model 415(1) to obtain maximum and minimum rates at which data must be output from SMB FIFO 1117 to avoid overflow or underflow in SMB FIFO 1117 and overflow or underflow in VBV model 415(1). Channel controller 1113 outputs these rates via 1121 to central bitrate controller 1007, which selects a rate for the next time slice on the basis of the information from channel controller 1113, the current output requirements of all of the other channel controllers 113, and the total capacity of the output stream. Central bitrate controller 1007 returns the selected rate to channel controller 1113, which sets throttle counter 1132 accordingly. Throttle counter 1132 then determines how many bits are actually output by throttle 1125 during the next time slice.

As shown in FIG. 11, packet director 1101 is implemented by means of gate arrays and a dual port RAM memory. Counters 1107 and 1123 are also implemented using gate arrays and channel controller 1113 is a digital signal processor. Central bitrate controller 1007 is implemented using a microprocessor with a support IC.

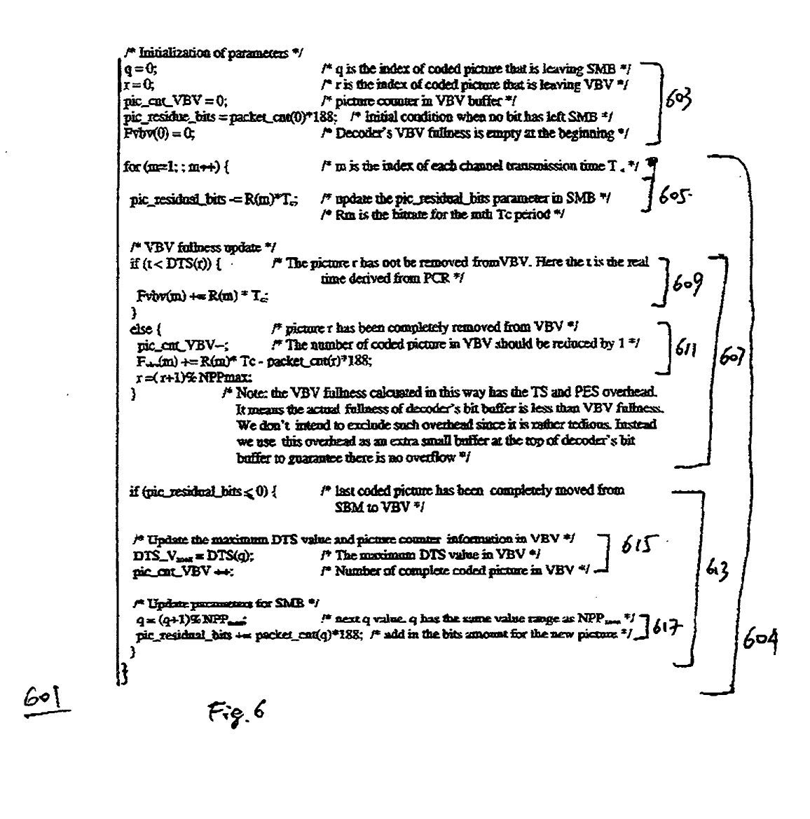

Detailed Description of Algorithms used to Compute the Output Rate for a Bit stream 109(i) from Statistical Multiplexer 401: FIGS. 6, 7, and 12

As indicated above, the maximum rate Rₘₐₓ at which a transmission controller 407(i) may output packets 113 to medium 207 is determined by the need to keep SMB buffer 507(I) from underflowing and bit buffer 119(i) from overflowing. The minimum rate Rₘᵢₙ is determined by the need to keep SMB buffer 507(i) from overflowing and bit buffer 119(i) from underflowing. Bit buffer 119(I) will not underflow if all packets belonging to the picture currently being sent arrive in bit buffer 119(i) before the time indicated in the DTS stamp for the picture.

There are thus two maximum rates and two minimum rates that need to be taken into account in determining Rₘₐₓ and Rₘᵢₙ:

Rₘₐₓ₁ is the maximum rate at which bit buffer 119(I) in any MPEG-2 decoder that conforms to the standard will not overflow;

Rₘₐₓ₂ is the maximum rate at which SMB 507(I) will not underflow;

Rₘᵢₙ₁ is the minimum rate at which bit buffer 119(I) will not underflow; and

Rₘᵢₙ₂ is the minimum rate at which SMB 507(I) will not overflow.

Rₘₐₓ and Rₘᵢₙ are determined from the above four maxima and minima as follows:

Rₘₐₓ is the minimum of Rₘₐₓ₁ and Rₘₐₓ₂.

Rₘᵢₙ is the maximum of Rₘᵢₙ₁ and Rₘᵢₙ₂. What is needed to compute Rₘᵢₙ₁ and Rₘₐₓ₁ is a VBV model 415(I) that models the fullness and emptiness of bit buffer 119(I); what is needed to compute Rₘᵢₙ₂ and Rₘₐₓ₂ is a measure of the fullness and emptiness of SMB buffer 507(I). The model for the fullness of bit buffer 119(I) is termed herein VBV fullness and the model for the emptiness of bit buffer 119(I) is termed herein VBV emptiness. The algorithms for measuring VBV emptiness and SMB buffer emptiness and fullness are simple and will be dealt with first; the algorithm for measuring VBV fullness is substantially more complex.

In the case of SMB 507(I), the measure of SMB emptiness, E_{SMB}, is the amount of free space remaining in SMB 507(I). For a given time slice T_{c} 211 (m), it is defined as follows:

E_{SMB}=SMB_SIZE−F_{SMB}(m);

where F_{SMB} is the actual SMB fullness measured by the Meter 505. Since there is a maximum size for MPEG-2 pictures, termed herein VBV_SIZE, the way to prevent SMB 507(I) from overflowing is to guarantee that there is always an empty space in SMB 507(I) that is larger than or equal to VBV_SIZE. If the free space becomes less than that, the minimum rate with regard to SMB 507(I), Rₘᵢₙ₂, must be increased in the next time slice T_{c} (m+1) according to the algorithm below:

if (E_{SMB < VBV}_SIZE) {

Rₘᵢₙ₂(m+1) = (VBV_SIZE − E_{MSB} (m))/T_{c};

}

Rₘₐₓ₂ is computed as follows:

Rₘₐₓ₂(m+1)=F_{SMB}(m)/T_{c}

Continuing with the determination of Rₘᵢₙ₁ for the next T_{c} from VBV model 415(I), the rate can be found from the information in VBV model 415(I) concerning the pictures 111 in SMB 507(I). The rule is simply this: the minimum bit rate must be such that the picture currently being output is completely output from SMB 507(I) before the time indicated by its DTS time stamp. One implementation is

Rₘᵢₙ₁(m+1)=pic_residual_bits (q)/(DTS_{—}Vₘₐₓ−t);

Here, pic_residual_bits is the number of bits of the picture 111 remaining in SMB 507(I), q is the index of the picture currently being transmitted from SMB 507(I) and q+1, q+2, . . . are the indexes of the following pictures, DTS_Vₘₐₓ is the time stamp with the most recent time in VBV model 415(I), and t is the actual time determined by the synchronization time value in the bit stream.

The above algorithm guarantees that all bits belonging to the picture 111 which is currently being delivered to bit buffer 119(I) will have been delivered before the decoding time DTS_Vₘₐₓ arrives. This algorithm may leave only one coded picture in the decoder's bit buffer for decoding. While this picture could be decoded correctly, a high bit rate will be necessary to deliver the next picture on time such that all the bits belong to the next picture, p+1, will be available for decoding at the next decoding time instance. This requirement will result in a high bitrate requirement for next T_{c} period and will introduce congestion in the delivery media at the next T_{c} period. A better algorithm is one that guarantees at least two pictures (or more, as long as VBV model 415(I) does not indicate an overflow) in bit buffer 119(I), such as the following:

Rₘᵢₙ₁(m+1)=pic_residual_bits (q)/(DTS(q−1)−t)

In this scheme, the minimal bitrate calculation is slightly changed by using the second largest value of DTS in bit buffer (119(I), DTS (q−1). That is the time stamp for the picture 111 preceding the last picture 111 to be sent to bit buffer 119(I). This scheme guarantees that the picture p has already be delivered to decoder 115(I) at t=DTS (q−1). Of course, it is even better to set up the minimal bit rate so that the number of coded pictures in bit buffer 119(I) is usually more than 2.

Determining VBV Fullness: FIG. 6

When there is no need to prevent overflow of SMB 507(I), the maximum bitrate of bit stream 109(I) is determined from the VBV fullness indicated by VBV model 415(I). The greater the VBV fullness indicated by the model, the less the maximum bitrate. At the beginning of the operation of model 415(i), SMB 507(i) is empty and VBV fullness indicates that model 415(i) is empty. As soon as bits appear in SMB 507(i), central bitrate controller 501 begins outputting them at a predetermined initial rate, for instance, the average rate for such variable-rate bit streams. As bits are received in SMB 507(i) and output to medium 207, the picture information in VBV model 415(i) is updated each time slice. The newly updated information is used to compute VBV fullness for the next time slice and the VBV fullness is used in turn to determine the maximum bit rate Rₘₐₓ₁ at which bits will be output on bit stream 109(i) for the next time period. The computation is the following:

Rₘₐₓ₁(m+1)=(VBV_SIZE−F_{vbv}(m)/T_{c}

where F_{vbv} is the VBV fullness measure provided by VBV model 415(i) and m and m+1 are the current and next time slices T_{c} 211.

In the preferred embodiment, the computation of F_{vbv} (m) is governed by the following considerations:

The calculation requires a computation of the number of pictures 111 are currently contained in VBV model 415(I).

The calculation requires a knowledge of how many bits of the picture 111 which is currently being transmitted from SMB 507(I) presently remain in SMB 507(i).

The data items used to compute F_{vbv} (m) in the preferred embodiment include the following:

a. VBV_SIZE, that is, the maximum size of a MPEG-2 picture.

b. The absolute maximum bit rate Rₘₐₓ which packet delivery controller 419 can provide to bit stream 109(i).

c. The current time, t, recovered from the clock time information of bit stream 109(i).

d. Data items for each picture presently in SMB 507(i): packet_cnt, the number of packets 113 in the picture, DTS, the time stamp for the picture, q, the index for DTS and packet_cnt for the picture currently leaving SMB 507(I), and r, the index for those values for the oldest picture for which there is still information in model 415(i).

e. Status data items in VBV model 415(i) that are updated every T_{c} 211: pic_cnt_VBV, the number of pictures 111 which are presently represented in VBV model 415(i); pic_residual_bit (q), the number of bits of picture 111 q that is currently being transmitted to decoder 115(i) that remain in SMB 507 (i); DTS_Vₘₐₓ, the time stamp with the most recent time stamp value that is presently in VBV model 415(i); and F_{vbv} itself.

As soon as SMB 507(i) begins receiving bit stream 109(i), packet delivery controller 419 sets throttle 509(i) to the initial rate provided by central bit rate controller 509. As packets are read from SMB 507(i) at that rate, transmission rate controller 413(i) updates DTS_Vₘₐₓ, pic_cnt_VBV, F_{vbv}, and pic_residual_bits (q) as required by the transmission of pictures from SMB 507(i) to decoder 115(i) and by the addition of bits to SMB 507(i). The algorithm 601 used to do this in a preferred embodiment is shown in FIG. 6. Section 603 of algorithm 601 shows how the parameters are initialized at the time the first picture arrives in SMB 507(i). Execution of loop 604 begins when the first bits of the picture arrive in SMB 507(i). As shown at 605, the loop is executed once every T_{c} 211. At the beginning of each execution of loop 604, pic_residual_bits is decremented by the number of bits that were sent at the rate R (m) previously determined for the current T_{c} 211 by central bitrate controller 501.

At 607, F_{vbv} is computed. There are two cases. In the first case, shown at 609, the time stamp DTS for the current picture r in VBV model 415(I) indicates a time that is after the current time t for bit stream 109(i), so decoding of the picture r cannot yet have begun. Consequently, the bits that were sent during the last T_{c} 211 are simply added to the bits that are already in VBV model 415(I) and F_{vbv} is incremented by that amount. If the comparison of t and DTS (r) indicates that decoder 115(i) has already begun decoding the picture r, the second case, shown at 611, is executed. pic_cnt_VBV is decremented to indicate that one less picture is now represented in VBV model 415(i) and F_{vbv} is adjusted by the difference between the number of bits sent to decoder 115(i) in the last T_{c} 211 and the total number of bits in the picture that is no longer represented in VBV model 415(i). After picture r is removed from VBV model, 415(i), the index r is incremented by 1.

Block of code 613 deals with the updating that has to be done when a picture q has been completely read from SMB 507(i). When that is the case, pic_residual_bits will have a value that is less than or equal to 0. The first updating that has to be done is shown at 615. The time stamp DTS for the picture 111 that was just sent is now the maximum DTS in Bit buffer 119(i), so DTS_Vₘₐₓ is updated with DTS (q). A picture q has also been added to the pictures represented in VBV model 415(i), so pic_cnt_VBV is incremented accordingly. The second updating is at 617. The new current picture is the next picture in SMB 507(i), so q is updated accordingly. Similarly, pic_residual_bits is set to the number of bits in the new current picture.

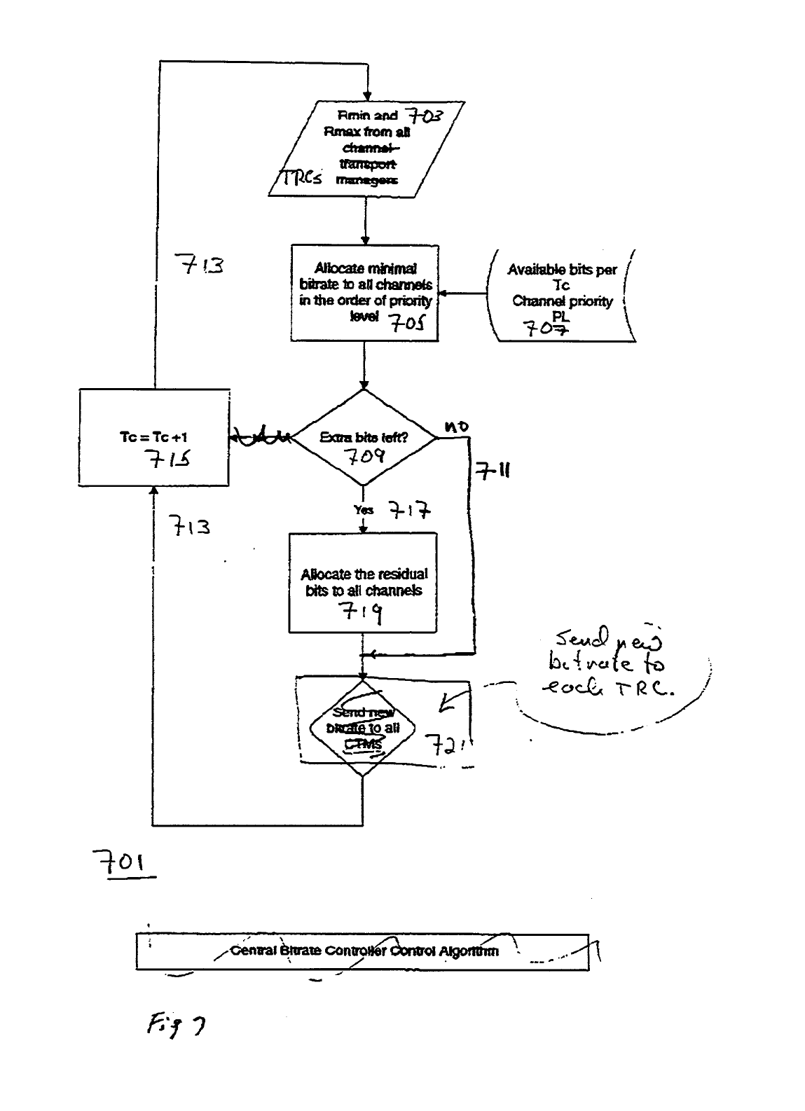

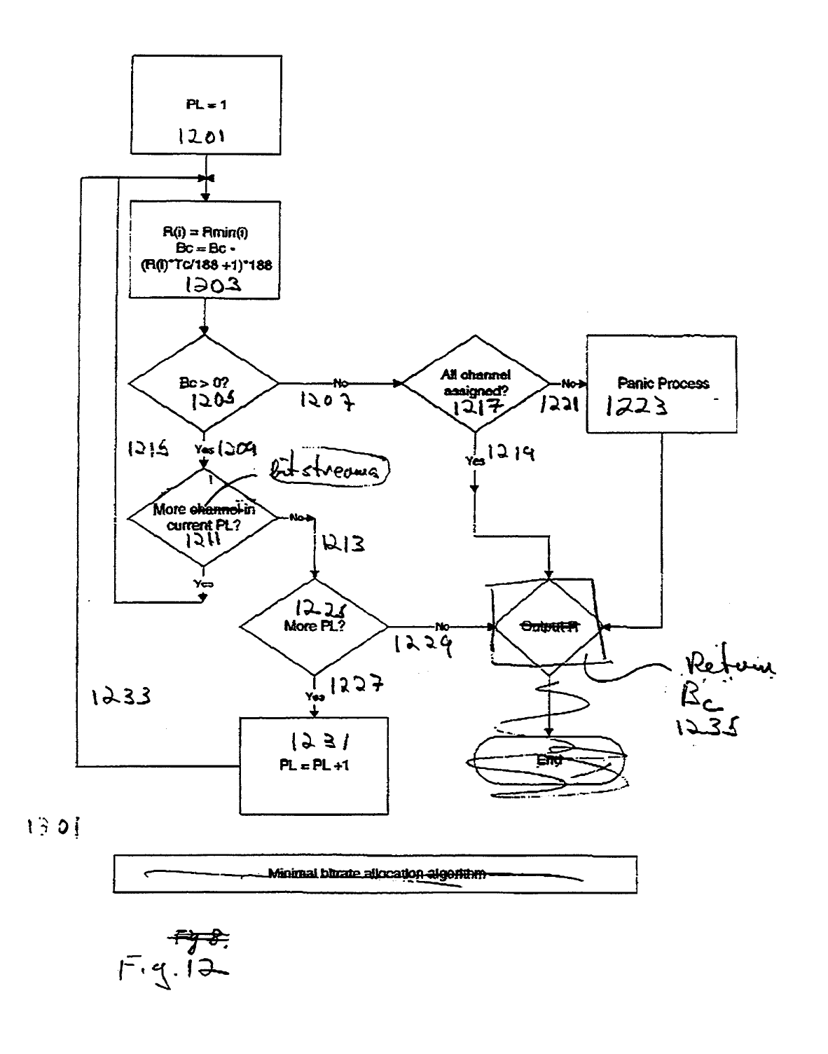

Allocating the Total Capacity of Medium 207 among the Channels: FIGS. 7 and 12

FIG. 7 shows a flowchart 701 of the CBC control algorithm that is used to assign the new bitrate for each VBR encoder for the next T_{c} period. The control algorithm is a loop 713 that executes each T_{c}. At the start of the loop, Rmin and Rmax from each TRC(i) are collected. The total available bits per Tc parameter, Bc, has already been calculated. Bc will be only updated when there is a change of channel bandwidth, Rc, which only happens rarely. Bc is calculated as

Bc=Rc*Tc

where Tc is in units of seconds.

Bc is divided among the bit stream 109 in accordance with the ranges of rates specified by the TRCs (0 . . . n) and in accordance with a set of priorities which indicate which bit streams 109 are more important. The priorities are provided by the operator of processor 907 and are set for each bit stream when the multiplexer is initialized for the bit stream. In the preferred embodiment, there are three levels of priority, according to the extent to which timely delivery of the pictures in the bit stream is required:

PL=1: Every picture in the bit stream will be delivered, and each of them will be delivered on time.

PL=2: Some picture will always be delivered on time. For example, a picture may be repeated to keep bit buffer 115(i) from underflowing.

PL=3: No time guarantees. The bit stream could even be interrupted to give the channel to another bit stream.

PL 1 and 2 are used for real-time video programs. PL 3 is used for preemptible data, that is, data which has no real-time requirements. Examples of such data are non-real time video programs or non-time-dependent data such as E-mail. PL 3 permits full use of the available bandwidth in situations where the sum of the video data is less than the total available bandwidth. The total bandwidth available that T_{c} and the priority for each bit stream 109(i) is provided by input block 707. The total bandwidth, the priorities, and the maximums and minimums for the channels are employed in block 705 to allocate a minimal bit rate to each bit stream 109(i). Details on the algorithm used to do this will be given below.

Once the minimal bit rates for all bit stream 109(0 . . . n) have been allocated, the algorithm subtracts the allocated bit rates from the total bandwidth to determine whether any bandwidth remains (709). If none is left, the allocation is finished and as shown at 711. 721, and 715, the bandwidth allocated to each TRC 413(i) is assigned to it (721) and loop 713 is repeated for the next T_{c}. If there are bits left (branch 717), the residual bits are assigned to the bit streams 109(i) that can take more bits (719). The algorithm for doing this is also explained in more detail below. Once the residual bits have been assigned, blocks 701, 715, and loop 213 are executed as described above. There remains, of course, the possibility that there is not enough total bandwidth to perform the allocation of block 705. This worst-case scenario is called Panic mode and will be further discussed later.

Minimal Bitrate Allocation Algorithm, FIG. 12

FIG. 12 shows a flowchart 1201 for this algorithm. The algorithm allocates a minimal bitrate to each TRC 413(i) and returns the number of bits still available to be allocated. The allocation is ordered by priorities, beginning with PL=1, as shown in block 1201. The remainder of the flowchart consists of an inner loop 1215, which is executed for each TRC 413(i) belonging to a given priority and an outer loop 1233 which is executed for each priority. The algorithm terminates when any of three conditions occurs:

there is no more bandwidth to allocate;

rates have been allocated to all bit streams 109(0 . . . n);

allocations have been made for all of the priorities.

Continuing in more detail with inner loop 1215, in block 1203, the TRC 413(i) to which bandwidth is currently being allocated receives the amount determined by Rₘᵢₙ (i) for that TRC 413(i). The bandwidth is rounded to complete 188-bit packets. In decision block 1205, it is determined whether there is any bandwidth left. If not, branch 207 is taken, terminating loop 1215; if there is, loop 1215 continues to decision block 1211, where it is determined whether there are more bit streams 109(i) having the current priority. If there are, loop 1215 is repeated; otherwise, as indicated by branch 1213, the program enters a new iteration of outer loop 1213. In that loop, decision block 1215 first checks whether there is another priority level to be processed; if there is (branch 227), PL is incremented and a new set of iterations of inner loop 1215 for that priority begins. If there is no additional priority level, loop 1233 terminates, as seen at branch 1229.

Looking at the termination conditions in more detail, if there is no more bandwidth to be allocated, branch 1207 is taken. In decision block 1217, it is determined whether there are any bit streams 109(i) for which a minimal bandwidth must still be allocated. If there are none, branch 1219 is taken and the remaining bandwidth is returned at 1235. If there are still bit streams 109(i), the program takes branch 1221 and enters the panic process 1223, which deals with the problem as required by the priorities of bit streams 109(0 . . . n) and then returns the remaining bandwidth at 1235. Similarly, branch 1229, taken when all priority levels have been processed, returns the remaining bandwidth at 1235.

Continuing with panic process 1223, if a bit stream 109(i) cannot receive the minimum rate it requires, one of two things may occur, depending on the bit stream:

SMB 507(i) may overflow, causing loss of data.

bit buffer 119(i) in decoder 115(i) may underflow, causing interruption of the display of pictures.

In the first case, either the input to SMB 507(i) must be decreased or the output from bit SMB 507(i) must be increased. Generally, the second solution can be employed in the short term and the first in the longer term. Beginning with the second solution, the extra bandwidth must be taken from priority 2 and 3 bit streams, beginning with bit streams 109(i) with priority 3. These bit streams have no time constraints and can be denied any bandwidth at all for as long as is necessary. Bandwidth can also be taken from priority 2 bit streams 109(i) that have space in their SMBs 507(i) by having them output a repeat of a picture until the panic condition is over or until their SMB 507(i) threatens to overflow. Of course, what the repeat produces at the receiver is a still picture. Because the repeat picture is totally redundant with regard to the picture it is repeating, it always has fewer bits than that picture.

Given that the reason for the substitution is to free up bandwidth, it is desirable to make the repeat picture as small as possible. That is achieved by sending a repeat of a coded picture that is not used to predict other pictures. B pictures fulfill this criterion, as do P pictures that immediately precede an I picture in sequences that do not contain B pictures. The substitution technique requires that transmission controller 413 for a PL 2 bit stream respond to an indication of a panic from central bitrate controller 1007 by reading header information to determine the type and size of the picture being output and when it finds the proper kind of picture, following it with repeat pictures until the panic is over.

Where the problem is underflow of bit buffer 119, if the bit stream is a priority 1 bit stream, extra bandwidth must again be found and the techniques described above must be applied. If bit stream 109(i) is a priority 2 bit stream, the techniques described for priority 1 bit streams may be employed, or if that is not possible, the bandwidth required for the bit stream may be reduced by outputting a minimal-sized repeat picture as described above until the panic condition is over or until overflow of SMB 507(i) threatens.

Where the problem is the threatened overflow of one or more SMB buffers 507, it may also be addressed by decreasing the bit rate at which the encoders 107 produce data. If the encoders 107 are co-located with statistical multiplexer 401, feedback from multiplexer 401 to the encoders may be used to do this. With this kind of feedback, there is no requirement that multiplexer 401 understand the inner workings of encoders 107. All that the signal to a given encoder 107(i) need indicate is that the encoder must reduce its ouput rate by some amount. Which encoders receive the signal can be determined in many fashions by multiplexer 401. One approach is to reduce the bit rate (and therefore the image quality) in channels on the basis of their priority levels; another is to reduce the bit rate in all channels equally. Typically, taking bandwidth from other bit streams would be a short-term solution that would be employed until the encoding rate could be changed. In the preferred hardware embodiment, short-term panic management is done in central bitrate controller 1007, while long-term panic management is done in control processor 907.

Algorithm for Allocating Residual Bits

When each of the bit streams 109(i) has received its minimum bitrate and there is still bandwidth remaining in medium 207, this residual bandwidth B_{c} is allocated among the bit streams in the preferred embodiment by allocating each bit stream 109(i) an additional bit rate ΔR(i) which is proportional to the difference between the maximum and minimum bit rates computed by TRC 413(i) for the bit stream. ΔR(i) is calculated in the preferred embodiment as follows:

$$Δ R ( i ) = \frac{{R}_{max} ( i ) - {R}_{min} ( i )}{{\sum }_{i} ( {R}_{max} ( i ) - {R}_{min} ( i ) )} \frac{Bc}{Tc}$$

In a preferred embodiment, all of the bit rates involved in the above computation are rounded to an integer number of packets per second.

Using the Principles of the Statistical Multiplexer to Implement a Splicer that can Control the Bit Rate of its Output Bit Stream

The following discussion will disclose how the principles employed in the design of the statistical multiplexer can be used to implement a splicer that can control the bit rate of its output stream and how such a splicer is able to solve many of the problems of splicing. The discussion will begin with a more detailed description of the MPEG-2 bit stream, will continue with a discussion of the problems which the MPEG-2 bit stream poses for a splicer, and will conclude with a description of an implementation of a splicer that can control the bit rate of its own output stream and can thereby solve many of the problems posed by the MPEG-2 bit stream.

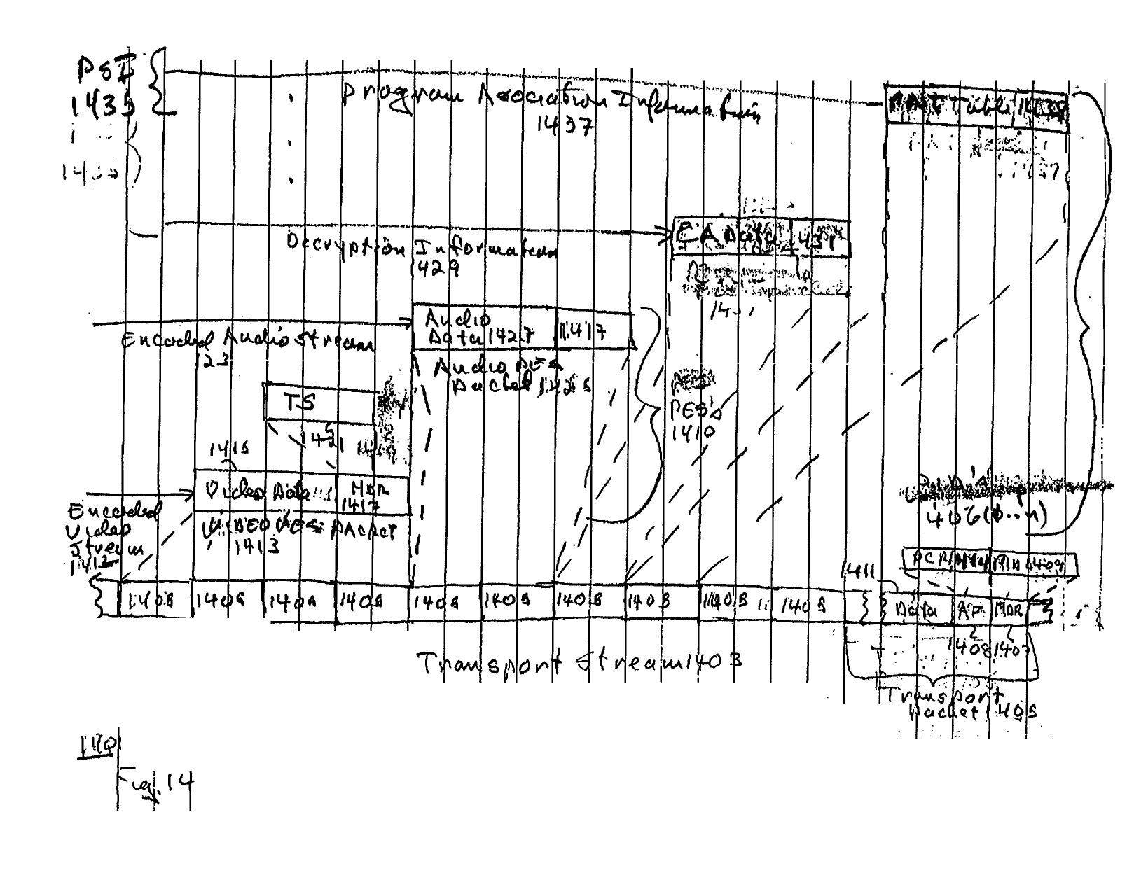

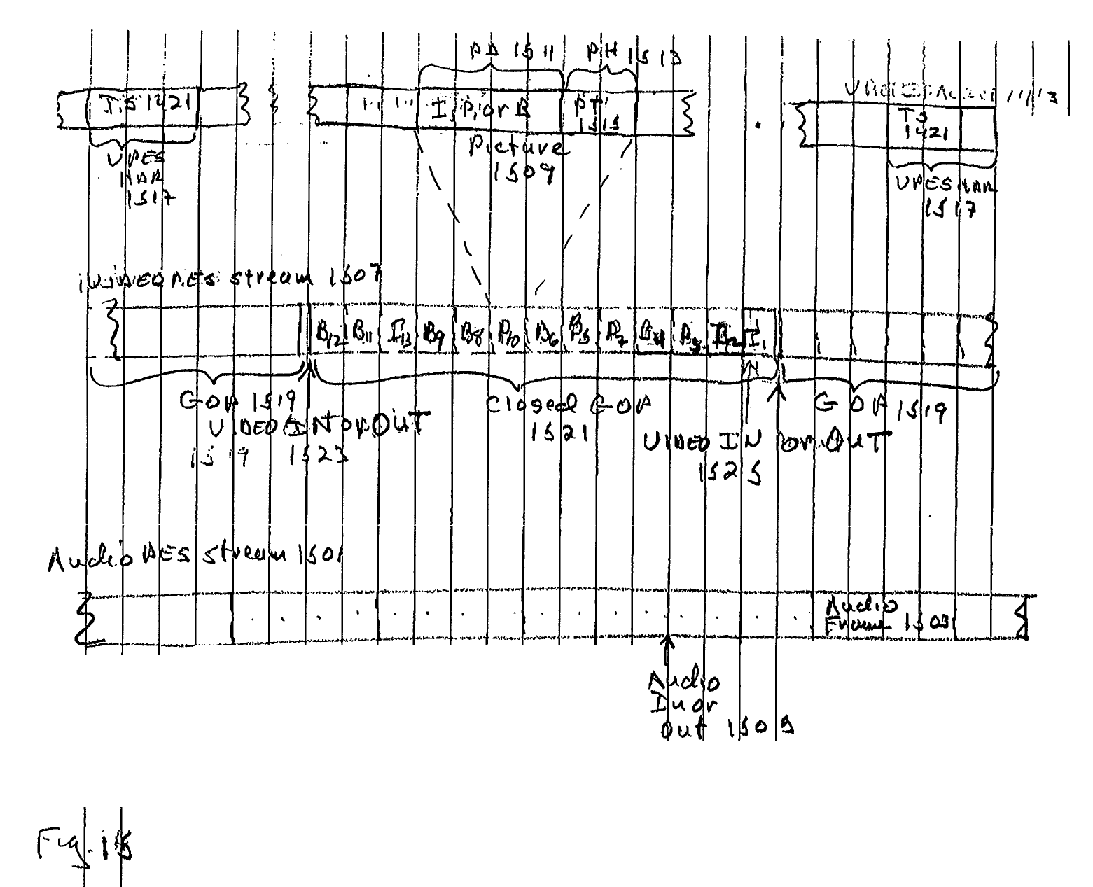

Detailed Overview of the MPEG-2 Bit Stream: FIGS. 14 and 15

FIG. 2 of the parent patent application provided a very high-level overview of the MPEG-2 bit stream which was sufficient for the purposes of explaining the statistical multiplexer disclosed in the parent; however, a more extensive knowledge of the MPEG-2 bit stream is required to fully appreciate the complexities of splicing such bit streams. FIG. 14 provides a detailed overview of a MPEG-2 transport stream 1403. Transport stream 1403 is made up of a sequence of transport packets 1405. The transport packets 1405 carry the information which makes up a video program. Each kind of information is identified in the transport packet that carries it by a Packet Identifier value (PID value). Therefore, a given kind of information is often termed a PID and the program is said to be made up of a number of PID's 1406. A given PID may contain one of three kinds of data:

A packetized elementary streams (PES) 1410. PES's carry the audio and video components of the program. Associated with a PES 1410 are time stamps which determine when the components of the PES are to be displayed, played or in some cases, decoded.

A table section. Table sections contain data which is used to locate other data in the MPEG-2 stream. For example, the PAT table PID in FIG. 14 contains PAT information, which specifies the PIDs that carry Program Map Tables (PMTs), and the PMT in turn indicates the PIDs that carry the PES's and other information belonging to the program.

Private data, that is, data that is not defined by the MPEG-2 standard. Here, the private data is a conditional access (CA) PID which carries information used to control access to encrypted or scrambled video and audio PES's. The CA PIDs are defined in a Conditional Access Table, or CAT.

The PAT, PMT, and CAT sections make up program specific information (PSI) 1435. The number of PIDs for a program will depend on the program; for example, a program may have several audio PES's and a program to which access is not restricted will not require an access control PID.

Transport packets 1405 are fixed-length. Each transport packet 1405 contains at a minimum a header field 1407 and a payload field 1411 and/or a varying-size adaptation field 1408. A bit in header 1407 indicates whether an adaptation field 1408 is present and the first byte of adaptation field 1408 indicates the field's size. When the adaptation field 1408 is present, the size of any payload field 1411 in the packet is reduced by the size of adaptation field 1408. Payload field 1411 in a transport packet 1405 carries data from one of the PIDs 406 belonging to the program. Each transport packet 1405 has a PID field 1409 in hdr 1407. The value inPID field 1409 specifies the PID 406(i) to which the data in payload field 1411 of transport packet 1405 belongs. Transport packets 1405 may of course be transmitted across a network using a variety of transport protocols. The size of transport packets 1405 as specified by the MPEG-2 standard is specifically adapted to transmission using the ATM (Asynchronous Transfer Mode) protocol.

FIG. 14 shows four PIDs 1406: an audio PES, a video PES, a CA data PID, and a PAT section PID. In the PES's, payload field 1411 of the transport packet carries audio and video PES packets. FIG. 14 shows a video PES packet 1413, which contains at least part of a video picture in video data 1415, an audio PES packet 1425 which contains at least part of an audio frame in audio data 1427, CA PID data 1431 and a PAT table 1439. The audio and video PES packets may be of varying lengths, with the length of a given audio or video PES packet depending on the signal being encoded and the kind of encoding used.

PIDs are mapped onto transport packets as follows: a given transport packet 1405 carries data from only one PID; if the data is packetized and the packet's header is being carried in the transport packet, the packet's header must immediately follow header 1407 or adaptation field 1408, if there is one. If the packet, table, or data (collectively, “information”) carried by a PID requires fewer bits than those provided by the transport packets 1405 the information is mapped onto, the payload field of the last transport packet carrying the information is filled out with stuffing. A transport packet 1405 which carries the beginning of information carried by a PID has a payload-unit-start flag set in its header. To make the mapping clear, FIG. 14 shows transport stream 1403 as though the transport packets 1405 carrying a given PID were contiguous in transport stream 1403. In fact, however, transport packets 1405 are placed in transport stream 1403 as they are produced by the encoders and other entities that produce the PIDs, and consequently, transport packets 1405 with payloads 1411 belonging to the various PIDs will be intermixed in transport stream 1403.

When a MPEG-2 transport stream is received in a receiver, the receiver must be able to coordinate decoding the audio and visual PESs and outputting the audio and visual signals resulting from the decoding. For instance, with a television program, the audio signal represented by the audio PES must be output by the receiver at the same time that the sequence of pictures that the audio signal accompanies and that is represented by the video PES is output by the receiver. To achieve this coordination, the MPEG-2 transport packets contain clock data and the audio and video PES's contain time stamp data. The system which is producing transport stream 1403 has a system time clock (STC). At least 10 times per second, transport stream 1403 contains a transport packet 1405 whose adaptation field 1408 contains a program clock reference (PCR) value 1414 which specifies the STC value at the time the transport packet 1405 carrying PCR 1414 was made. The receiver reads the PCR values 1414 from transport stream 1403 and uses them to make its own system time clock (STC) for the program in the receiver. Different programs may of course have PCRs made from different STCs. If processing a transport stream involves delay, the PCRs in the transport stream must be modified to reflect the delay. One example of such a delay is that caused by remultiplexing a transport stream; another is splicing.

The headers 1417 for audio and video PES packets may contain time stamps 1421 that specify times based on the same STC used for the PCRs. There are two kinds of time stamps: presentation time stamps ITS) and decoding time stamps (DTS). The PES packets in every audio and video PES must include a presentation time stamp (PTS) every 700 ms. The time specified by the PTS is the time as measured by the receiver's STC at which the receiver is to provide the audio or video signals represented by the pictures or audio frames contained in the PES packets to the television set. Some PES video packets contain a DTS as well. The DTS indicates the time as measured by the receiver's STC by which the receiver is to have decoded the packet. The DTS is necessary because the order in which PES video packets must be decoded may be different from the order in which they are displayed. The receiver must receive the video and audio PES packets at a rate which is fast enough that the receiver can decode and present the PES packets by the times specified in the DTS and PTS. The rate must not, however, be so fast that the buffers used to store the encoded and decoded pictures and video frames in the receiver overflow. The BPEG-2 standard uses a Video Buffer Verifier (VBV) model in the encoder to ensure that the pictures are produced with sizes and time stamps such that the picture buffers in a receiver whose picture buffer sizes and decoder speed conform to the model will neither overflow nor underflow.

Considerations in Splicing Transport Streams

As will be apparent from the foregoing, the timing requirements of MPEG-2 bit streams need to be taken into account in splicing. Here, and in the following discussion of splicing, the MPEG-2 transport stream which is terminating at the splice will be termed the old transport stream and the one that is beginning at the splice will be termed the new transport stream:

The old and new transport streams may have PCR values based on different STCs;.

The first time stamps in the new transport stream must indicate times relative to the last time stamps in the old transport stream that are the same as the times that would have been indicated in the next time stamps in the old transport stream if there had been no splice.

the new audio and video PES's must come at a rate that ensures that the receiver buffers, which still contain material from the old audio and video PES's, to do not overflow or underflow.

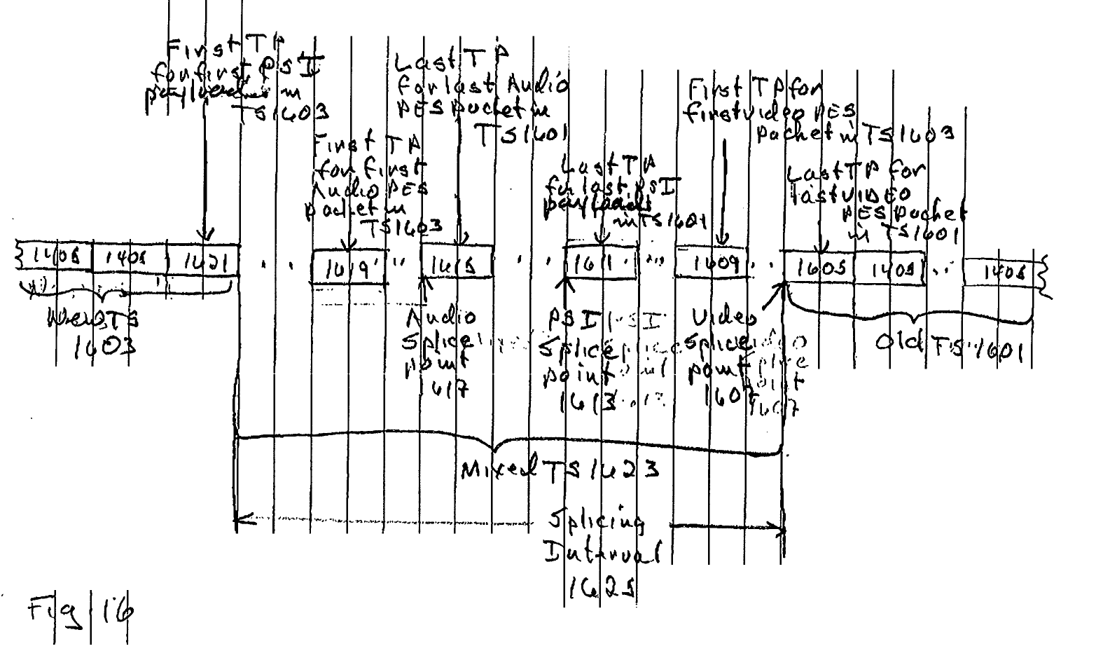

Splicing transport streams is further complicated by the fact that the information carried by each PID in the program must be spliced. Since payloads from all of the PIDs are mapped serially onto the transport stream, that means that the splicing cannot be done instantaneously, but over an interval of time which will be termed the splicing interval. During the splicing interval, the transport stream being received by the receiver will contain transport packets belonging to PIDs from both the old and the new transport streams. This is shown in FIG. 16. There, a new transport stream 1603 is being spliced to an old transport stream 1601. In the figure, the splicing for a video PES, a single PSI PID, and a single audio PES are shown; in most cases, of course, there will be a number of audio PESs and a number of PSI PIDs. Splicing interval 1625 is the interval between the time that the transport stream contains only data belonging to PIDs from the program being carried by old TS 1601 and the time that it contains only data belonging to PIDs from the program being carried by new TS 1603. During this interval, the TS is a mixed TS 1623, in that it carries data from PIDs belonging to both old TS 1601 and new TS 1603, as shown by TS packets 1609, 1611, 1615, and 1619.

Each PID in old TS 1601 that has an equivalent PID in new TS 1603 has its own splice point in splicing interval 1625. The splice point is the point in time at which the last TS packet containing data from the given PID is placed in the transport stream. Thus, the video splice point is at 1607, the PSI splice point is at 1613, and the audio splice point is at 1617. The order in which the PIDs are spliced and the interval between the time that the last TS packet for a PID belonging to old TS 1601 and the first TS packet for a PID belonging to new TS 1603 appears in the transport stream are determined by timing considerations and the semantics of the MPEG-2 stream. The general requirement is simple: the splicing must be done such that the information needed by the receiver to process a payload belonging to a given PID must be available in time to to do the processing. For example, decoding pictures is much more time consuming than decoding audio frames; consequently, the video PES packets for a picture that is to be displayed by the receiver at a given time will precede the audio PES packets for an audio frame that is to be played at the given time, and therefore, the video splice point 1607 will generally precede the relevant audio splice point 1617. The same is the case with other PIDs. If a PES stream in old TS 1601 is encrypted with one key and the corresponding PES stream in new TS 1603 is encrypted with a different key, the splicing for the PID that contains decryption information for the encrypted PES must be done such that the decryption information for the encrypted PES is available when the receiver needs to perform the decryption.

Considerations in Splicing Video PES's

Splicing video PES's is complicated by the manner in which pictures are encoded in MPEG-2 . As mentioned in the parent patent application, there are three kinds of encoded pictures: intra coded pictures, or I pictures, which can be decoded without reference to any other picture, predictively coded pictures, or P pictures, which must be decoded with reference to pictures that precede them in the display order, and bidirectionally predictive pictures, or B pictures, which may be decoded with reference to pictures that precede them in the display order, pictures that follow them, or both. FIG. 15 shows how these pictures appear in a video PES stream 1507. Each picture 1509 has a header 1513, which indicates whether the picture is an I, P, or B picture, and picture data 1511, which is encoded according to the method indicated in the header. A number of pictures 1509 are organized into a group of pictures (GOP) 1519. A GOP must begin with an I-picture.

A closed GOP is independently decodable, i.e., decoding the pictures in the GOP requires no information from pictures outside the GOP. If a GOP is not closed, it is open. A closed group of pictures is shown at 1521. The pictures in the group are shown in the order in which they are sent, which is the order in which they must be decoded because of dependencies between the pictures. Thus, the first B picture, B₂, follows the I and P pictures that contain the information needed to decode B₂. The order in which the pictures in GOP 1521 will be displayed when decoded is indicated by the subscripts on the picture types. The pictures in a GOP may be contained in one or more video PES packets. The headers 1517 of these packets of course contain time stamps.

The best place to splice a video PES stream is at the beginning or end of a closed GOP 1521. The old video PES stream and the new video PES stream may begin or end at either point. The point at which the old video PES stream may end is termed herein a video OUT point, shown at 1523, and the point at which the new video PES stream may begin is termed a video IN point, also shown at 1523. When both video PES streams are made up of closed GOPs, both the IN and the OUT points will be at the boundaries between closed GOPs. Of course, not all video PES streams have closed GOPs, and it may also be inconvenient or impossible to wait for a closed GOP. At a minimum, both the IN and OUT points must be at the boundaries between pictures 1509; in the case of the old video PES stream, the OUT point must immediately precede an I or a P picture; in the case of the new video PES stream, the IN point should immediately precede an I picture. Where even that is not possible, it may be necessary to begin output of the new video PES stream by adding a still-frame repeat copy of the last I picture preceding the IN picture in the new video PES stream and then adding synthetic B pictures referencing the copy of the I picture as required for the new video PES stream to satisfy the VBV buffer overflow and underflow requirements of the receiver. The I picture and the B pictures must of course have the same dimensions as the other pictures in the sequence. As explained in the discussion of panic handling in the parent of the present patent application, the synthetic B pictures, which require relatively little bandwidth, can also be used to temporarily minimize the bandwidth requirements of the new video PES stream following the splice.

Considerations in Splicing Audio PES's

FIG. 15 also shows encoded audio frames 1503 in an audio PES stream 1501. With audio frames, the problem of finding an in or out point is much simpler; as shown in FIG. 15, the audio in or out point 1505 may be at any frame boundary. Otherwise, the requirements are the following:

The splice must occur at the end of a coded frame in the ‘old’ bit stream.

The splice must occur at the beginning of a coded frame in the ‘new’ bit stream.

The sampling rate of the ‘old’ and ‘new’ bit streams must be the same.

The interval between the presentation times of the audio frames in the ‘new’ bit stream (indicated by the PTS) must be a continuous extension of the PTS intervals of the ‘old’ bit stream. This applies even when the PCR-defined timebase is switched at the splice time.

The audio must fade down just before the splice point and up just after it to avoid an audible click.

As already pointed out, audio and video cannot be spliced simultaneously. Thus, until the audio splice point is reached, audio PES packets from the old transport stream will be included in the new transport stream. This places further constraints on the coding of DTS and PTS if the PCRs in the new transport stream are defined by a different STC than the one that defines them in the old transport stream. As noted in the MPEG Systems semantic definition for the discontinuity indicator, PTS's relating to the old transport stream's PCRs may not be present in the new transport stream. Thus if a PCR is carried in the video PES and there is a PCR discontinuity at the video splice time, there must not be any PTS from the ‘old’ audio PES from that moment until the audio is spliced some time later.

Considerations in Splicing Encrypted PES's

Encryption or scrambling is often used in broadcasts to control access to the video and audio signals being broadcast. Information necessary to decrypt or descramble the video and audio is typically carried in a conditional access PID that accompanies the video and audio PES's in the transport stream. If the splice is from a transport stream with encrypted PES's to one with unencrypted PES's or vice-versa, there is no need to synchronize the decryption information in the conditional access PID with the unencrypted PES's as long as any necessary decryption information is available when it is needed. However, if both the old and new transport streams have encrypted PES's, the decryption information used to decrypt the encrypted PES's in the old transport stream will not decrypt the encrypted PES's in the new transport stream. Consequently, it is necessary to synchronize the change from the old transport stream's conditional access PID to the new transport stream's conditional access PID with the changes from the encrypted PES's of the old transport stream to the encrypted PES's of the new transport stream.

As it is difficult to determine precisely the arrival time of decryption information relative to the scrambled or encrypted elementary data, it is recommended that the decryption information for either the old or the new transport stream not be updated during the time required to splice all of the PES's of the program. Special rules need to be added to the MPEG-2 standard for the splicing of private data such as the decryption information. Another solution to the problems posed by scrambling or encrypting is to ensure that all inputs to a splicer are unscrambled, with scrambling and the PID stream for the decryption information being added after scrambling. This solution does require that the PMT (program map table, a PSI PID which relates the PIDs of a program to the PID values of the transport packets that carry the PIDs and which indicates where the PCRs for the service are located in the transport packets) be modified at the time of encryption to point to the PID for the conditional access PID. This approach may, however, also make it possible to control access to a program at a local level, for example at the transition between satellite and cable delivery systems with local conditional access control at the cable head end.

Considerations in Splicing PSI PIDs

It is possible that at a splice point some elements of a service will be added or deleted, such as extra audio channels or subtitling data. This will require changes in the PSI PIDs, including updating of the PMT. In addition, it is likely that other PSI tables such as the DVB Event Information Table (EIT) or Service Description table (SDT) will need to be revised. Ideally new table sections with updated version numbers would be inserted exactly at the splice point, prior to any packets of the transport stream being sent. However due to the necessary offset between a video splice and an audio splice there is no unique splice point for a whole program: splicing of all PIDs in a program will take place over an interval of time. Furthermore, the MPEG-2 standard has defined neither the maximum processing time required for a change in a PSI PID nor the moment at which such a change takes effect for a decoder which has received such a change. In the absence of guidance from the standard, some common-sense guidelines may be established and some cautionary observations made.

No PSI or SI tables relating to the old transport stream shall be sent after the first PES in the program is spliced.

After the final PES of a program has been spliced the transmission rates of PSI and SI sections shall follow the rules set down by the applicable standards document.

During the course of splicing elements of a program it is not possible to guarantee the accuracy of all the information found in PSI and SI tables. In general this is not catastrophic as these are ‘information’ tables, not essential to the decoding of a service. It should be noted that such items as EIT present/following may well contradict earlier versions of the table.

Splicing with Downloaded Data

The MPEG-2 transport stream can be used to carry any kind of digital data, including program code and data used by downloaded programs. Such digital data is of course carried in its own PID. When a program or data for a program are being downloaded, it is necessary that all the code or data be received if the program is to function. Splices of PIDs carrying program code or data should therefore only occur in gaps between downloads. In PIDs carrying such data, it may be useful to adopt a convention that the payload_unit_start_indicator signals a suitable IN point for a splicer (and by implication the end of the previous transport packet would be an OUT point).

It should be noted that for any broadcast data channel the assumption must be that the link is unreliable and can only support connectionless communications. The decoder must not be left in a disabled state if the data download is interrupted.

Splicing with Data Embedded in Video User Data

There is a syntax in MPEG-2 for carrying Picture User Data in a video PES to support such features as closed captioning. The Picture User Data may not be intended for presentation at the same time as the associated coded picture. Decoders should expect discontinuities due to splicing and include features that compensate e.g., an old caption should not be left on display indefinitely if no further caption data is received.

Splice Quality

A splice has succeeded only if the transport stream and PES's resulting from the splice not violate the MPEG-2 standard. A successful splice may, however have varying degrees of quality. The following quality definitions are taken from Perkins and Helms, a proposed standard for splicing, Contribution to SMPTE working group PT20.02, 1996.

Seamless splices to do not induce decoding or display discontinuities. A necessary condition for a seamless splice is that the decoding time of the first access unit (a coded picture or audio frame) from the spliced stream is consistent with respect to the decoding time of the last access unit of the old stream. In other words, the first access unit from the spliced stream will be decoded at the same time that the first post-splice access unit of the old stream would have been decoded if the splice had not occurred. This decoding time is referred to as the seamless decoding time.

Non-seamless splices induce decoding discontinuities. This means that the decoding time of the first access unit from the new stream does not equal the seamless decoding time. However, it is possible to create non-seamless splices that appear seamless to the viewer. That is, non-seamless splices can be constructed that produce no unacceptable artifacts.

In the following, a splice of either the seamless or non-seamless variety which cannot be perceived by the viewer or listener will be termed an invisible splice; a splice which cannot be perceived by examining the transport stream will be termed an undetectable splice.

Undetectable splices are desirable because they may aid in defeating “commercial killer” devices, that is, devices which disable display of commercials on the television set connected to the receiver. Such a “commercial killer” device would work by reading the MPEG-2 stream looking for indications of splices. If it finds one, it disables reception by the TV set of the material contained between the splice (which marks the beginning of the commercial) and the next splice (which marks its end).

Obviously, a splice will not be undetectable if it is made using the MPEG-2 splicing parameters. The requirements for an undetectable splice are the following:

the continuity counter must be continuous according to MPEG Systems semantics.

the PCR must be continuous. This requires over-writing of all time stamps.

parameters in the Sequence Header must not change, and the ‘End of Sequence’ code should not be used in the transport stream.

the time code in the GOP header must be continuous

other more detailed characteristics that mark different encoder algorithms or states must be continuous.

The ability of the splicer to modify the output transport stream makes it possible to achieve many of the above requirements, but for others, it is often impractical at the level of the splicer to maintain the necessary continuities. Completely undetectable splicing may thus be attainable only by prior arrangement with the sources of the old and new transport streams to insure that similar coding parameters are used in both.

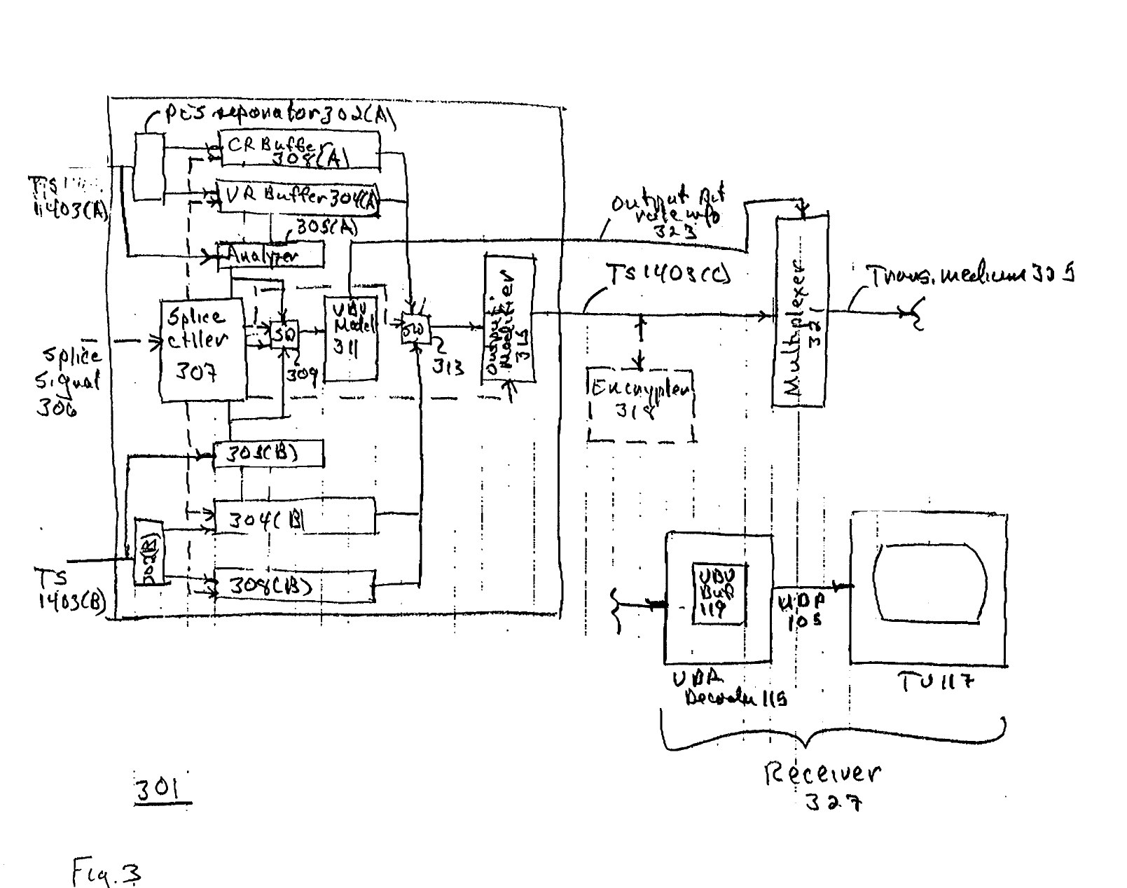

A Splicer that Preserves Timing and Bandwidth Requirements Across a Splice: FIG. 3

Most discussions of video splicing operations assume that the bit rate of the bit stream output by the splicer is the same as that of whatever bit stream is currently being input to the splicer. The approach presented here is to use a splicer that can control the bit rate of the bit stream output by the splicer. The splicer can use its control of the bit rate of the output bit stream to ensure that the bit rate and timing requirements of the beginning of the new transport stream are compatible with those of the end of the old transport stream. This capability is by itself sufficient to prevent overflow or underflow of buffers in the receiver; moreover, if such a splicer can additionally pick IN and OUT points of PIDs and modify the output transport stream, it can always achieve non-seamless splices and can very often achieve seamless splices and even invisible splices. Further, since it can do all of the above without the presence of MPEG-2 splice parameters in the PIDs, it can contribute substantially to the achievement of undetectable splices.

Such a splicer must have access to the following information:

the PTS and DTS in the video PES;

the sequence and picture header data in the video PES; and

the number of payload bytes and transport packets between sequence or picture start codes.

With this information the splicer can maintain a VBV model for the receiver as discussed in the parent of the present application (See in particular the sections Overview of a Preferred Embodiment, Detailed Description of Algorithms used to Compute the Ouput Rate, and Determining VBV Fullness) and can use this model to regulate the rate of delivery of video data to the decoder so that its buffers will neither overflow nor underflow. A splicer of this type becomes even more effective if it is used in an environment which permits quick alterations in the amount of bandwidth that is made available to the transport stream output by the splicer. One example of such an environment is the statistical multiplexer which is described in the parent of the present patent application. In that statistical multiplexer, the bandwidth requirements of each transport stream that the multiplexer is multiplexing onto the transmission medium are determined in response to the transport stream's VBV model; consequently, the same mechanisms that are used to ensure that the end of the old transport stream and the beginning of the new transport stream are compatible with each other can be used to quickly and automatically adjust the bandwidth provided to the new bit stream to its requirements.

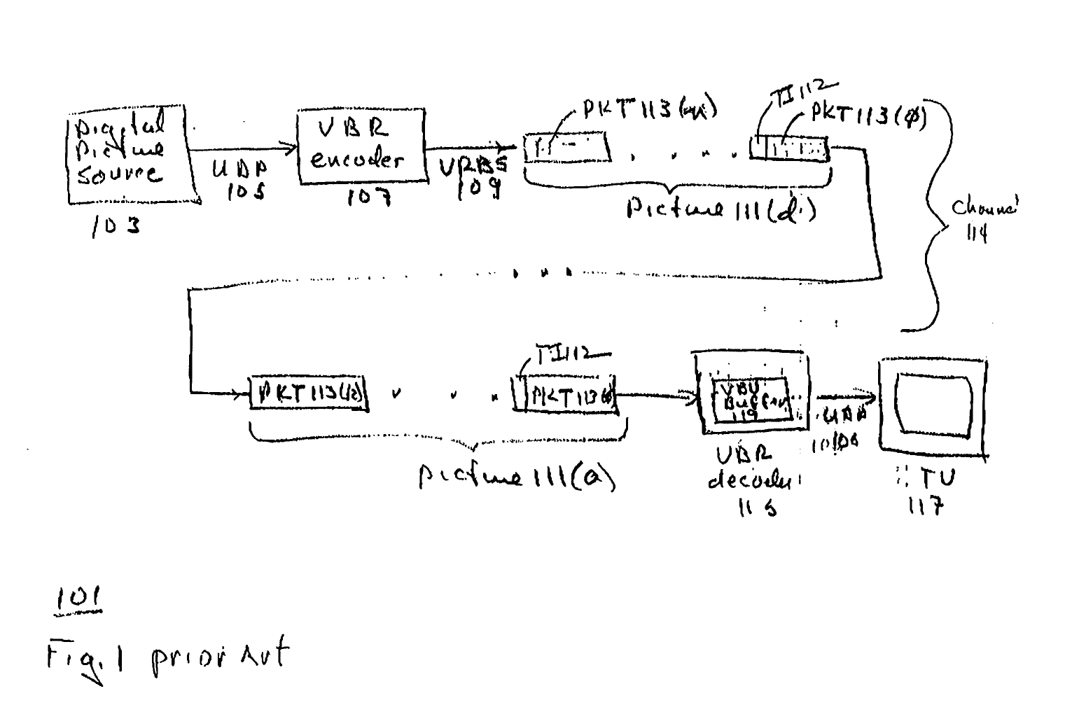

FIG. 3 is an overview of a system 301 containing a splicer such as the one just described. Splicer 303 of FIG. 3 is to be understood as taking two bit streams 109(A and B) (which may or may not be variable rate) as shown in FIG. 1 of the parent as inputs and producing as its output a variable-rate bit stream 109(C), which is then transmitted to a VBR decoder 115, where it is decoded. VBR decoder 115 then provides at least signals corresponding to the audio and video elements of variable bit rate stream 109 to TV 117. When the splicer is being used to splice MPEG-2 streams, the inputs and outputs are transport streams 1403, with transport stream 1403(A) being the old transport stream, transport stream 1403(B) being the new transport stream, and transport stream 1403(C) being the spliced transport stream.

Transport stream 1403(C) goes to multiplexer 321, where it is multiplexed onto transmission medium 325 with a number of other transport streams 1403. In some embodiments, at least the video and audio packets in transport stream 1403(C) may be encrypted by encryptor 318. It should be noted here that splicers of the type of splicer 303 may be used not only with MPEG-2 streams, but with any bit streams that include timing information. In FIG. 3, data paths are represented by means of solid arrows, while control paths are represented by means of dashed arrows.

Splicer 303 includes a PID separator 302, a continuous rate buffer 308, a variable rate buffer 304, and an analyzer 305 for each input transport stream 1403(A and B). PID separator 302 reads the PID in each transport packet and separates the transport packets according to their PIDs. Video PES's, which usually have a varying bit rate, go to variable rate buffer 304, which stores video PES packets until they are output to transport stream 1403(C). Packets belonging to the other PIDs go to constant rate buffer 308, where they are stored until they are output to transport stream 1403(C). Output from buffers 308 and 304 goes via switch 313 and output modifier 315 to TS 1303(C). Switch 313 and output modifier 315 are controlled by splice controller 307. Output from buffers 304 and 308 is controlled by movable read pointers for the buffers. Analyzer 305 reads the input transport stream it is associated with for the information that is relevant to the splicing operation. Depending on the nature of the MPEG-2 stream and the quality of splicing desired, the analyzer may also read information such as picture type and GOP headers from the video PES, decryption information from the conditional access PID, and information from other relevant PSI PIDs. Information from the analyzers 305 goes to splice controller 307 and to VBV model 311.

As described in the parent of the present application, VBV model 311 receives PCR, time stamp, and video packet size information and uses that information to determine the state of a hypothetical VBV buffer 119 in decoder 115 that has received all of the pictures sent thus far from buffer 304 to decoder 115. Having determined VBV buffer 119's state, VBV model 311 determines maximum and minimum rates at which picture packets of the transport stream it is receiving information about must be sent to decoder 115 in order to avoid overflow or underflow of VBV buffer 119 and overflow or underflow of the buffer 304. As shown by output 324, the rate information goes to multiplexer 321, where it is used to determine how much of the total bandwidth of transmission medium 325 that transport stream 1403(c) is to receive. It is possible to make a VBV model without any specific knowledge of VBR decoder 115 because the required behavior of VBV buffer 119 in any MPEG-2 decoder is defined by the MPEG-2 standard.

In splicer 303, VBV model 311 receives its information concerning PCRs, time stamps, and video packet sizes from three sources: the analyzer 305 for each of the input transport streams 1403(A and B) and splice controller 307. Before the splice point for the video PES, the information for the model comes from old transport stream 1403(A); at the splice point, the information comes from splice controller 307; after the splice point, it comes from new transport stream 1403(b). Switching from one source to another is done by switch 309, which is controlled by splice controller 307.

Output modifier 315 modifies transport stream 1403(C). Modifications may involve changing the values of PCRs and time stamps, inserting information into adaptation fields, modifying audio frames to eliminate the “click” at the splice, and even inserting synthetic pictures of the B and P types into transport stream 1403 (C). Output modifier 315 operates under control of splice controller 307. That component, finally, controls the other components as required to do the splice given the information collected by the analyzers from transport streams 1403(A) and (13) and the receiver state indicated by VBV model 311. As will be set forth in more detail below, splice controller 307 can begin a splice either in response to an external splice signal 306, in response to a splice command in a PID of old transport stream 1403(A), or in response to the appearance of data in buffer 304(13). The components of splicer 303 may be implemented completely in software, completely in hardware, or in a mixture of the two. Implementation choices will be governed by the price, performance, and availability of components.

Operation of splicer 303 is as follows: at the time splicer 303 begins a splice operation, buffer 304(A) contains transport packets from old transport stream 1403(A) and buffer 304(B) contains transport packets from new transport stream 1403(B). The source of new transport stream 1403(B) may be able to fill buffer 304(B) and then pause until the splice is done or it may continually produce new transport stream 1403(B). In the latter case, splice controller 307 moves the read pointer in buffer 304(B) so that transport packets whose PCRs are older than the current value of the STC for new transport stream 1403(13) are simply discarded. VBV model 311 is receiving information about old transport stream 1403(A) and indicates the state of VBV buffer 119 after it has received all of the transport packets of old transport stream 1403(A) that have been sent from buffer 304(A).

Upon beginning the splice operation, splice controller 307 uses the information it has received from analyzer 305(A) to find the next OUT point in the portion of transport stream 1403(A) contained in buffer 304(A). Ideally, of course, that OUT point will be the end of a closed group of pictures 1521; if that is not possible, it will at a minimum be a picture boundary. If B-pictures are present, the splice point must be immediately prior to a reference (I- or P) picture in the ‘A’ stream. Splice controller 307 similarly finds the first video IN point in buffer 304(B). The IN point must be just prior to a sequence header which is followed by an I-frame. After finding the IN point, splicer can set the read pointer to that point, thereby discarding all of the contents of buffer 304(B) which precede the IN point in transport stream 1403(B). Splice controller 307 also determines from the information it has received from analyzers 305(A) and (B) about transport streams 1403(A) and (B) what modification of transport stream 1403(B) will be necessary for the splice. Among the possible modifications are the following:

If the splice point in new transport stream 1403 separates B-pictures from I or P pictures which contain the information needed to decode the B pictures, then the initial B-pictures after the IN point which may reference unavailable data from a previous GOP are replaced by a still-frame repeat of the last I picture before the IN point and synthetic coded B-pictures which reference only the repeat of the I picture. The horizontal and vertical dimensions of these synthetic pictures must match the rest of the ‘B’ stream. The splicer is able to to do this making use of the horizontal_size and vertical_size codes from the sequence header and the closed_GOP flag in the GOP header. VBV model 311 is updated to reflect the changed size of the coded B-pictures that are output.

If the ‘A’ or ‘B’ streams employ repeat_first_field or top_field_first MPEG syntax to encode 24 fps movie material for NTSC display then it may be necessary to insert a synthetic ‘3-field’ picture at the splice point in order to ensure continuity of the top/bottom field sequence at the decoder output. Splicer 303 is able to determine if this is necessary by inspecting the progressive_sequence, progressive_frame, picture_structure, top_field_first and repeat_first_field codes in the sequence extension and picture extension headers. VBV model 311 is updated accordingly.

The decoding time of the first picture following the splice point in new transport stream 1403(B) must be the same as that of the picture in old transport stream 1403(A) that immediately follows the splice point in old transport stream 1403(A) (or a notional picture, if the ‘OUT point’ occurred exactly at the end of the video sequence). To achieve this, the PCR associated with the new stream must have an offset added or subtracted so that the decode times are regular across the splice boundary in the manner required by MPEG. The VBV model must be updated with the new STC for transport stream 1403(B) that results from adding or subtracting the offset. The DTS-matching offset is in addition to any offset that must be added to reflect the propagation delay imposed by the splicer equipment. To support DTS matching, enough of output transport stream 1403(C) is buffered prior to output to multiplexer 321 to permit storage of one picture's worth of coded data (worst case). The value of the DTS-matching offset is computed to keep the difference between the input ‘B’ STC and the modified output ‘B’ STC within the range +/− one field period, plus the splicing process delay.

If the new stream has different sequence header parameter values from the old stream, then in order to be MPEG compliant a sequence end code must be inserted. The splicer can to do this by inserting an extra transport packet containing only a sequence end code as payload. The packet is inserted exactly at the juncture between the ‘A’ and ‘B’ streams. It is recommended that this packet also contains a PCR related to the ‘B’ STC in its adaptation field and also has the discontinuity indicator set.

If the ‘A’ and ‘B’ streams to do not share the same time base (as indicated by the PCRs) then a discontinuity must be signaled prior to the splice to advise decoder 115 of the impending time base transient. The discontinuity indicator is located in adaptation field 1408 of transport packet 1405, so an opportunity to signal a discontinuity indicator happens at least whenever a PCR is coded. However, if the PCR is not carried in the video PES, it is useful to insert a transport packet 1405 with no payload at the juncture between the ‘A’ and ‘B’ streams to mark the discontinuity in the transport packet continuity_count and in the video time stamps.

When all of the contents of buffer 304(A) up to the splice point in that buffer have been output to multiplexer 321, splicer 307 stops output from buffer 304(A). If necessary, splicer 307 uses output modifier 315 to insert a transport packet 1405 at the splice point and then switches to buffer 304(B). The switching is done at switch 313. It also changes the STC in VBV model 311 as required by the PCRs of transport stream 1403(B), sets switch 309 so that VBV model 311 is receiving information from analyzer 305(B), and uses output modifier 315 to make any necessary modifications to transport stream 1403(B). To the extent that the modifications change the number of bits output to multiplexer 321, splice controller 307 updates VBV model 311 to reflect the changes.

The new information received by VBV model 311 is now coming from transport stream 1403(13), but VBV model 311 still takes into account the state of VBV buffer 119 at the time the output was switched from transport stream 1403(A) to 1403(B) and will provide a range of rates as input 323 to multiplexer 321 which will ensure that the rate at which data from transport stream 1403(I) is transmitted following the splice will be within the following constraints:

Buffer 304(B) will not overflow;

VBV buffer 119 in decoder 115 will not overflow or underflow.

the available bandwidth of the multiplex will not be exceeded.

Moreover, as transport stream 1403(B) continues to be output, VBV model 311 will continue to output information 323 to multiplexer 321, which will use the information to optimize the amount of bandwidth given to transport stream 1403(B) in transmission medium 325. On the next splice, of course, transport stream 1403(13) will be the old transport stream and transport stream 1403(A) will be the new transport stream.

Because splicer 303 splices using information from the two transport streams being spliced and can rely on VBV model 311 to provide the proper bandwidth at the time of the splice, a splice made by splicer 303 will usually succeed. At worst, a well-behaved decoder response can generally be achieved by the use of substitute synthetic coded pictures. If the splice can be made at closed GOP boundaries, it will be seamless and in most cases invisible. Splicer 303 also greatly simplifies the making of undetectable splices; to begin with, splicer 303 does not require splicing parameters to work; further it can be used to make most of the changes in the output stream that are required for an undetectable splice.

Signaling a Splice

Among the ways a splice may be signaled are by an external splice signal 306 received in splicer 303, by control codes in the MPEG-2 stream being carried in either transport stream, and by the presence of data in the buffer 304 for the new transport stream.

Signaling a Splice with Splice Signal 306

When the splice is signaled by splice signal 306, both inputs are ‘live’ streams that are continuously presenting transport packets to the splicer. Prior to the splice the ‘B’ signal is being monitored to determine the location of I-frames (‘IN points): these are held in the buffer (with all subsequent data) for a pre-determined period (this affects the splicer delay), or until a new I-frame is detected, whereupon the old data is flushed from the buffer. The data is not flushed until after a pre-determined amount of data has arrived following the second I-frame, to ensure that sufficient data is available to prevent a VBV underflow.

Upon the splice command being received, the splicer identifies the first available OUT point in the ‘A’ stream. From the moment that the command is received, the splicer will set the discontinuity indicator in any PID of the program of which the ‘A’ stream is part whenever an adaptation field is detected. At the splice point, the splicer inserts any synthetic transport packets required (such as the insertion of a sequence end code or 3-field picture). After the splice occurs, the VBV model is monitored to regulate the output bit rate. Also, if B-frames are present, they may be replaced by synthetic backward-only coded pictures to close the first GOP after the splice. Synthetic B-frames (or P-frames) may also be useful in managing particularly stressful splice situations where the new stream has many large coded pictures and constrained ability to allocate sufficient bandwidth, as the synthetic pictures will invariably have fewer coded bytes than the picture that it replaces.

Signaling a Splice With Control Codes embedded in the MPEG-2 stream

In many applications it is convenient to trigger a splice using control codes embedded in either the old or the new MPEG-2 stream. For maximum convenience the trigger syntax should support commands that are immediate in action, and also commands which are referenced to a time code or PTS value. Three locations in an MPEG stream may be considered for the carriage of splice control codes:

1) User data in the video PES. This requires that the splicing point be known at the time that the video is encoded into MPEG. The data is somewhat awkward to access, and may not be available if the elementary stream is scrambled. This location may be useful for marking index points, as an alternative to using time code in the GOP header.

2) The adaptation field is used already for carrying splice-assist information, so it seems reasonable to extend the syntax to add splice control functionality. However, in certain markets the fact that the adaptation field is never scrambled may make this option unpopular, because it would support ‘Commercial Killer’ devices.

3) A separate data stream in a PID identified in the PMT as part of the program. This option has the most flexibility: it can be scrambled or unscrambled, and it can be stripped completely from a program as part of the splicing process. The infrequent nature and low bandwidth of splicing commands make the assignment of an entire PID for splicing commands in a program rather excessive. The splicing commands could, however, be combined with other program related information in a PID. One PID which might be used for splicing commands is the CA PID. Special messages could be sent in that PID together with the entitlement control messages (ECMs) used for access control. The CA PID is proprietary, and the form of a splicing command would depend on the conditional access system in use. The method is practical when considered from an operational perspective, and has the added benefit that encrypted splicing control codes cannot be read by commercial killer devices.

Self-switching Splices

The splice is initiated by data detected on one of the inputs. This can be considered a ‘self-switching’ mode and is useful for applications where the new transport stream is coming from a server (i.e., no stream is presented to the input until the wanted transport stream is spooled off the server). In this mode, as soon an I-frame is detected in buffer 304(B), the splicer will seek a splice point in the ‘A’ stream and promptly perform a splice. Conversely, at the end of the server playback, the bit rate at the ‘B’ input will drop to zero causing a time-out, and the splicer will switch to the closest IN point in the ‘A’ stream. This self-switching technique is useful because it avoids the need for precisely timed separate commands sent to the server to initiate playback and to the splicer to force the switch.

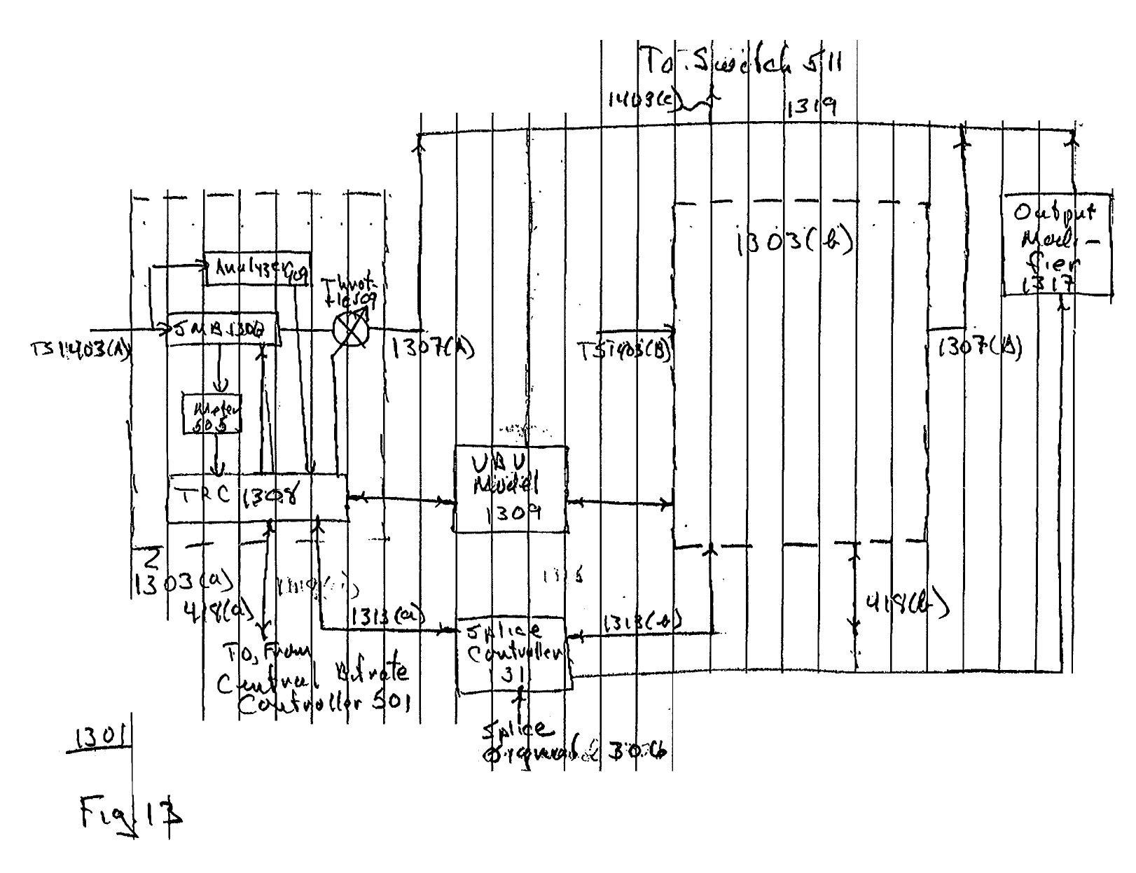

Implementing a Splicer in the Statistical Multiplexer of the Parent: FIG. 13

FIG. 13 shows how a splicer 1301 that has the properties of splicer 303 can be implemented in the environment of the statistical multiplexer of the parent patent application. FIG. 13 is based on FIG. 5 of the parent; the blocks labeled 1303 in FIG. 13 contain substantially the same hardware as the blocks labeled 407 in FIG. 5, except that in FIG. 5, each block 407 has its own VBV model 415, while blocks 1303(a) and 1303(b) in FIG. 13 share VBV model 1309. Additionally, the blocks 1303 have been coupled to splice controller 1311 and have been modified to permit splice controller 1311 to obtain the information and perform the operations required for splicing. FIG. 13 is related to FIG. 3 as follows: block 1303 corresponds to those components of FIG. 3 that deal with video PES streams; the components of FIG. 3 that handle constant-rate PID streams correspond to the portion of FIG. 5 labeled “bypass buffer”.

Continuing in more detail, both blocks 1303 have identical components; consequently, only those in block 1303(a) are shown in detail. Block 1303(a) receives old transport stream 1403(A); block 1303(b) receives new transport stream 1403(B); the outputs from the blocks 1303 go to common output 1319, which in turn is connected to switch 511 of FIG. 5. As explained in more detail in the discussion of FIG. 5 in the parent, switch 511 multiplexes transport packets of the transport stream 1403(C) currently being output from splicer 1301 onto the transmission medium at a rate which is within the range currently required for the transport stream.

Within block 1303(a), transport stream 1403(A) is stored in SMB buffer 1306, which has been modified so that splice controller 1311 can set the read pointer in the buffer as required for the splicing operations. Analyzer 409 examines transport stream 1403(A) for the information required by VBV model 1309 to maintain the model and the information required by splice controller 1311 to control the splicing operation. Additionally, meter 505 monitors the fullness of SMB 1306. TRC 1308 receives the information provided by analyzer 409 and meter 505, as well as VBV buffer fullness information provided by VBV model 1309. TRC 1308 uses the information to determine a range of rates at which block 1303 must output transport stream 1403 in order to avoid overflow or underflow in either SMB 1306 or VBV buffer 119 in the receiver and then provides the range of rates to central bitrate controller 501, which computes the actual bit rate at which transport stream 1403(A) will be output and returns that rate to TRC 1308, which sets throttle 509 accordingly and passes the new rate for throttle 509 to VBV model 1309. TRC 1308 also serves as an interface between splice controller 1311 and block 1303(a), providing information obtained from analyzer 409, meter 505, and VBV model 1309 to splice controller 1311 and responding to requests from splice controller 1311 to set the read pointer in SMB 409, to update VBV model 1309 as required by addition by splice controller 1311 of material to output transport stream 1403(c), to use throttle 509 to turn output from block 509 off or on, and to request bandwidth from central bitrate controller 501 only when throttle 509 is on.

Splice controller 1311 is further connected to output modifier 1317, which it uses to modify output stream 1403(C) produced by splicer 1301. Splicer 1301 operates in exactly the same fashion as splicer 303, and can be implemented using the hardware described in the section Hardware Implementation of a Preferred Embodiment of the parent. In terms of those figures, each block 1303 corresponds to a channel input 1009. In the splicer implementation, a pair of channel inputs 1009 would share a VBV model, a splice controller, and an output modifier.

Conclusion

The foregoing Detailed Description has disclosed to those skilled in the arts to which the invention pertains how to make and use a bit stream splicer which outputs a variable-rate bit stream in which a new bit stream has been spliced to an old bit stream. In a disclosed implementation, the splicer uses a model of a receiver of the bit stream and information from the bit stream to determine a rate at which the variable-rate bit stream must be output to avoid overflow or underflow in the receiver and bit-stream analyzers to determine the IN and OUT points of the bit streams being spliced. The Detailed Description has further disclosed how the splicer may be implemented using a multiplexer which employs the rates determined by receiver models to multiplex a set of variable-rate bit streams onto a medium and how the splicer may be used to splice bit streams that are encoded according to the MPEG-2 standard, and has given algorithms for the use of models of MPEG-2 receivers to compute rate requirements.

The Detailed Description has disclosed the best mode presently known to the inventor of implementing the splicer; it will, however, be immediately apparent to those skilled in the arts to which the invention pertains that the invention may be employed with bit streams other than those defined by the MPEG-2 standard. For example, the techniques for modifying the output bit rate to avoid underflow or overflow of the receiver buffer may be used with any kind of bit stream, while the techniques for locating splice points may be used with any bit stream that includes components which must be received in their entirety by the receiver. Specific implementations of the splicer will necessarily vary according to how the bit streams are defined. Even with regard to implementations that are used with MPEG-2 bit streams, there are many possible implementations. In particular, the splicer may be implemented completely in hardware or completely in software or in a mixture of the two. The implementations will further vary depending on whether non-seamless splices, seamless splices, invisible splices, or undetectable splices are desired and on the details of the MPEG-2 bit stream used in a particular broadcasting system.

For these reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

What is claimed is:

1. A splicer for receiving an old bit stream and a new bit stream, producing a varying bit-rate output stream with a splice between the old bit stream and the new bit stream, and providing the output stream to a receiver, the splicer having the improvement comprising:
a bit rate determiner for determining a bit rate for the output stream around the splice such that a buffer in the receiver which receives the output stream will neither overflow nor underflow; and
an output controller for providing the output bit stream at the determined bit rate.

2. The splicer set forth in claim 1 wherein:
the bit rate determiner does not require any splice parameter in the old bit stream in order to determine the bit rate.

3. The splicer set forth in claim 1 wherein the old and new bit streams contain transport elements and components which occupy more than one transport element, the receiver requires complete components, and the splicer further comprises:
a first bit-stream analyzer for reading the old bit stream to obtain first information about the components therein,
the output controller responding to the first information by selecting an OUT point at which the output controller ceases outputting the old bit stream to the output stream, the OUT point being at a boundary of a component.

4. The splicer set forth in claim 1 wherein:
the splicer further comprises a second bit-stream analyzer for reading the new bit stream to obtain second information about the components therein,
the output controller responding to the second information by selecting an IN point in the new bit stream at which the output controller begins outputting the new bit stream to the output stream, the IN point being at a boundary of a component.

5. The splicer set forth in claim 3 wherein:
the components are encoded and the receiver includes a decoder for decoding the components; and
the output controller further selects the OUT point such that interference by the splice with decoding is minimized.

6. The splicer set forth in claim 4 wherein:
the components are encoded and the receiver includes a decoder for the decoding the components;
the output controller further selects the IN point such that interference by the splice with decoding is minimized; and
the output controller provides the output bit stream such that the splice is done at the OUT point for the old bit stream and the IN point for the new bit stream.

7. A splicer for receiving an old bit stream and a new bit stream, each of which includes transport elements and components which occupy more than one tranaport element, producing a output stream with a splice between the old bit stream and the new bit stream, and providing the output stream to a receiver that requires complete components, the splicer having the improvement comprising:
a first bit-stream analyzer for reading the old bit stream to obtain first information about the components therein;
a second bit-stream analyzer for reading the new bit stream to obtain second information about the components therein; and
an output controller that responds to the first information by selecting an OUT point in the old bit stream and to the second information by selecting an IN point in the new bit stream, the OUT point and the IN point being selected such that they are on boundaries of components, the output controller further providing the output bit stream such that the splice is at the OUT point for the old bit stream and the IN point for the new bit stream.

8. The splicer set forth in claim 7 wherein:
the components are encoded and the receiver includes a decoder for decoding the components; and
the output controller further responding to the first information and the second information by selecting the OUT point and the IN point such that interference by the splice with the decoding is minimized.

9. The splicer set forth in any one of claims 5, 6, or 8 wherein:
the output controller does not require a splice parameter in the old bit stream in order to determine the OUT point.

10. The splicer set forth in any one of claims 5, 6, or 8 further comprising:
an output bit-stream modifier responsive to the output controller for altering the output bit stream around the splice to minimize interference by the splice with the decoding.

11. The splicer set forth in claim 10 wherein:
the output bit-stream modifier alters the output bit stream around the splice such that a non-seamless splice is invisible to the user of the receiver.

12. The splicer set forth in claim 10 wherein:
the old bit stream and the new bit stream include time values; and
the output bit-stream modifier alters the time values in the output bit stream so that they are continuous.

13. The splicer set forth in any one of claims 5, 6, or 8 wherein:
the output controller selects any of the IN or OUT points such that the splice is seamless.

14. The splicer set forth in any one of claims 1 through 6 wherein:
the bit rate determiner repeatedly determines the bit rate of the output bit stream such that the buffer in the receiver will neither overflow nor underflow; and
the output controller provides the output stream at the determined rate.

15. The splicer set forth in any one of claims 1 through 6 wherein:
the output stream is provided to the receiver via a multiplexer which dynamically allocates bit rates to the bit streams that it multiplexes;
the bit rate determiner provides a range of bit rates such that the buffer will neither overflow nor underflow;
the output controller provides the range of bit rates to the multiplexer; the multiplexer responds thereto by allocating a bit rate within the range to the output bit stream and indicating the allocated bit rate to the output controller; and
the output controller uses the allocated bit rate as the determined bit rate.

16. The splicer set forth in claim 5 or 6 wherein:
the bit rate determiner determines the bit rate of the output stream in response to information from the bit-stream analyzer that is reading the old bit stream prior to the splice and to information from the bit stream analyzer that is reading the new bit stream after the splice.

17. The splicer set forth in claim 16 wherein:
the bit rate determiner uses the information from the bit stream analyzers in a model of the receiver's buffer.

18. The splicer set forth in any one of claims 1 through 8 wherein:
the output controller operates in response to an external splice signal.

19. The splicer set forth in any one of claims 1 through 8 wherein:
the output controller operates in response to a splice command in either the old bit stream or the new bit stream.

20. The splicer set forth in any one of claims 1 through 8 wherein:
the output controller operates in response to the presence of the new bit stream's beginning in the splicer.

21. The splicer set forth in any one of claims 1 through 8 wherein:
the output controller operates in response to the presence of the old bit stream's end in the splicer.

22. A splicer for receiving an old MPEG-2 bit stream and a new MPEG-2 bit stream, producing a varying-rate MPEG-2 output stream with a splice between the old bit stream and the new bit stream, and providing the output stream to a receiver with a decoder for MPEG-2 bit streams, the splicer having the improvement comprising:
a bit rate determiner which uses a VBV model of the decoder to determine a bit rate for the output stream around the splice such that the decoder will neither overflow nor underflow; and
an output controller for providing the output bit stream at the determined bit rate.

23. The splicer set forth in claim 22 wherein:
the bit rate determiner does not require any splice parameter in the old bit stream in order to determine the bit rate.

24. The splicer set forth in claim 22 wherein the old and new bit streams contain encoded components that are decoded by the decoder, and the splicer further comprises:
a first bit-stream analyzer for reading the old bit stream to obtain first information about the encoded components therein,
the output controller responding to the first information by selecting an OUT point at which the output controller ceases outputting the old bit stream to the output stream, the OUT point being selected such that violation of MPEG-2 syntax or semantics by the splice is minimized.

25. The splicer set forth in claim 24 wherein the splicer further comprises:
a second bit-stream analyzer for reading the new bit stream to obtain second information about the encoded components therein,
the output controller responding to the second information by selecting an IN point in the new bit stream at which the output controller begins outputting the new bit stream to the output stream, the IN point being selected such that violation of MPEG-2 syntax or semantics by the splice is minimized; and
the output controller provides the output bit stream such that the splice is done at the OUT point for the old bit stream and the IN point for the new bit stream.

26. A splicer for receiving an old MPEG-2 bit stream and a new MPEG-2 bit stream, each of which includes encoded components, producing an MPEG-2 output stream with a splice between the old bit stream and the new bit stream, and providing the output stream to a receiver that includes a MPEG-2 decoder, the splicer having the improvement comprising:
a first bit-stream analyzer for reading the old bit stream to obtain first information about the encoded components therein;
a second bit-stream analyzer for reading the new bit stream to obtain second information about the encoded components therein; and
an output controller that responds to the first information by selecting an OUT point in the old bit stream and to the second information by selecting an IN point in the new bit stream, the OUT point and the IN point being selected such that violation of MPEG-2 syntax or semantics by the splice is minimized, the output controller further providing the output bit stream such that the splice is at the OUT point for the old bit stream and the IN point for the new bit stream.

27. The splicer set forth in any one of claims 24, 25, or 26 wherein:
the output controller does not require a splice parameter in the old bit stream in order to determine the OUT point.

28. The splicer set forth in any one of claims 25 or 26 wherein:
the model uses information from the bit-stream analyzer that is reading the old bit stream prior to the splice and information from the bit stream analyzer that is reading the new bit stream after the splice.

29. The splicer set forth in any one of claims 25 or 26 further comprising:
an output bit-stream modifier responsive to either the first or second information for altering the output bit stream around the splice such that the area around the splice does not violate MPEG-2 syntax or semantics.

30. The splicer set forth in claim 29 wherein:
the output bit-stream modifier alters the output bit stream around the splice such that a non-seamless splice is invisible to the user of the receiver.

31. The splicer set forth in claim 29 wherein:
the old bit stream and the new bit stream include time values; and
the output bit-stream modifier alters the time values in the output bit stream so that they are continuous.

32. The splicer set forth in claim 31 wherein:
the time values include time stamps in the encoded components.

33. The splicer set forth in any one of claims 25 or 26 wherein:
the output controller selects any of the IN or OUT points such that the splice is seamless.

34. The splicer set forth in any one of claims 25 or 26 wherein:
the encoded components include pictures; and
the output controller selects any IN or OUT point such that the IN or OUT point is at a picture boundary.

35. The splicer set forth in claim 34 wherein:
first certain of the pictures are required to decode second certain of the pictures; and
the output controller preferentially selects the picture boundary such that no picture on one side of the picture boundary requires a picture on the other side of the picture boundary for decoding.

36. The splicer set forth in claim 34 wherein
first certain of the pictures are required to decode second certain of the pictures; and the splicer further comprises:
an output bit-stream modifier responsive to the output controller for altering the output bit stream around the splice, the output controller employing the output bit-stream modifier to add synthetic pictures to the output bit stream so that no picture on one side of the splice is required to decode a picture on the other side of the splice.

37. The splicer set forth in any one of claims 25 or 26 wherein:
the encoded components include audio frames; and
the output controller selects any IN or OUT point such that the IN or OUT point is at an audio frame boundary.

38. The splicer set forth in any one of claims 24 or 26 wherein the output bit stream is carried in transport packets and the splicer further comprises:
an output bit-stream modifier responsive to the output controller for altering the output bit stream around the splice, the output controller employing the output bit-stream modifier to add a discontinuity indicator used by the decoder to a transport packet in the output bit stream.

39. The splicer set forth in any one of claims 24, 25, or 26 wherein the output bit stream is carried in transport packets and the splicer further comprises:
an output bit-stream modifier responsive to the output controller for altering the output bit stream around the splice, the output controller employing the output bit-stream modifier to insert an additional transport packet into the output bit stream that contains system time clock information used by the decoder.

40. The splicer set forth in any one of claims 24, 25, or 26 wherein the output bit stream is carried in transport packets and the splicer further comprises:
an output bit-stream modifier responsive to the output controller for altering the output bit stream around the splice, the output controller employing the output bit-stream modifier to insert an additional transport packet into the output bit stream that contains discontinuity information used by the decoder.

41. The splicer set forth in any one of claims 22 through 26 wherein:
the output controller operates in response to an external splice signal received in the splicer.

42. The splicer set forth in any one of claims 22 through 26 wherein:
the output controller operates in response to a splice command in either the old bit stream or the new bit stream.

43. The splicer set forth in any one of claims 22 through 26 wherein:
the output controller operates in response to the presence of the new bit stream's beginning in the splicer.

44. The splicer set forth in any one of claims 22 through 26 wherein:
the output controller operates in response to the presence of the old bit stream's end in the splicer.

45. The splicer set forth in any one of claims 22 through 25 wherein:
the output stream is provided to the receiver via a multiplexer which dynamically allocates bit rates to the bit streams that it multiplexes;
the bit rate determiner provides a range of bit rates such that the buffer will neither overflow nor underflow;
the output controller provides the range of bit rates to the multiplexer;
the multiplexer responds thereto by allocating a bit rate within the range to the output bit stream and indicating the allocated bit rate to the output controller; and
the output controller uses the allocated bit rate as the determined bit rate.
